(19) United States
(12) Patent Application Publication
(10) Pub. No.: US 2024/0380461 A1
(43) Pub. Date: Nov. 14, 2024

(54) WIDEBAND AND PER-SUBBAND CHANNEL STATE INFORMATION REPORTING FOR SUBBAND FULL-DUPLEX COMMUNICATIONS

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Peter GAAL, San Diego, CA (US); Wanshi CHEN, San Diego, CA (US)

(21) Appl. No.: 18/652,535

(22) Filed: May 1, 2024

Related U.S. Application Data
(60) Provisional application No. 63/501,994, filed on May 12, 2023.

(51) Int. Cl. H04B 7/06; H04L 5/14

(52) U.S. Cl. CPC H04B 7/0626; H04B 7/0639; H04L 5/14

(57) ABSTRACT

Methods, systems, and devices for wireless communication are described. A user equipment (UE) may receive a control message indicating a channel state information (CSI) reporting configuration for a subband full-duplex (SBFD) slot. The CSI reporting configuration may indicate that the UE is to report CSI for entire bandwidths of respective downlink subbands of the SBFD slot. That is, the CSI reporting configuration may configure the UE for per-downlink subband CSI reporting. The UE may receive CSI reference signals via the downlink subbands, and measure CSI for the reference signals. The UE may transmit, according to the CSI reporting configuration, a CSI report indicating the CSI for the downlink subbands. In some examples, the CSI may include some combination of channel quality indicators (CQIs) and precoding matrix indicators (PMIs).

### CROSS REFERENCE

The present application for patent claims the benefit of U.S. Provisional Patent Application No. 63/501,994 by IBRAHIM et al., entitled “WIDEBAND AND PER-SUBBAND CHANNEL STATE INFORMATION REPORTING FOR SUBBAND FULL-DUPLEX COMMUNICATIONS,” filed May 12, 2023, assigned to the assignee hereof, and expressly incorporated by reference herein.

### FIELD OF TECHNOLOGY

The present disclosure relates to wireless communication, including wideband and per-subband channel state information (CSI) reporting for subband full-duplex (SBFD) communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A UE and a network node may support subband full-duplex (SBFD) communications. In some examples, techniques for reporting channel state information (CSI) for different subbands of an SBFD slot may be improved.

### SUMMARY

The described techniques relate to improved methods, systems, devices, and apparatuses that support wideband and per-subband channel state information (CSI) reporting for subband full-duplex (SBFD) communications. For example, the described techniques provide for wideband channel quality indicator (CQI) and precoding matrix indicator (PMI) reporting for SBFD resources to support per-downlink subband PMI reporting. In some examples, a UE may receive a control message from a network node indicating a CSI reporting configuration for an SBFD slot. The CSI reporting configuration may indicate that the UE is to report different CSI for entire bandwidths of respective downlink subbands of the SBFD slot. The UE may monitor for CSI reference signals transmitted from the network node via the respective subbands of the SBFD slot. The UE may measure the CSI reference signals to generate the CSI for each subband, and the UE may transmit a CSI report including the CSI for each subband (e.g., the first CSI and the second CSI) in accordance with the CSI reporting configuration.

A method for wireless communication at a UE is described. The method may include receiving a control message indicating a CSI reporting configuration for a SBFD slot, where the CSI reporting configuration indicates that the UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot, monitoring for a first CSI reference signal via the first downlink subband of the SBFD slot and a second CSI reference signal via the second downlink subband of the SBFD slot, and transmitting, in accordance with the CSI reporting configuration, a CSI report indicating the first CSI for the first downlink subband of the SBFD slot and the second CSI for the second downlink subband of the SBFD slot.

An apparatus for wireless communication at a UE is described. The apparatus may include one or more memories, and one or more processors coupled to the one or more memories. The one or more processors may be configured to cause the apparatus to receive a control message indicating a CSI reporting configuration for a SBFD slot, where the CSI reporting configuration indicates that the UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot, monitor for a first CSI reference signal via the first downlink subband of the SBFD slot and a second CSI reference signal via the second downlink subband of the SBFD slot, and transmit, in accordance with the CSI reporting configuration, a CSI report indicating the first CSI for the first downlink subband of the SBFD slot and the second CSI for the second downlink subband of the SBFD slot.

Another apparatus for wireless communication at a UE is described. The apparatus may include means for receiving a control message indicating a CSI reporting configuration for a SBFD slot, where the CSI reporting configuration indicates that the UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot, means for monitoring for a first CSI reference signal via the first downlink subband of the SBFD slot and a second CSI reference signal via the second downlink subband of the SBFD slot, and means for transmitting, in accordance with the CSI reporting configuration, a CSI report indicating the first CSI for the first downlink subband of the SBFD slot and the second CSI for the second downlink subband of the SBFD slot.

A non-transitory computer-readable medium storing code for wireless communication at a UE is described. The code may include instructions executable by a processor to receive a control message indicating a CSI reporting configuration for a SBFD slot, where the CSI reporting configuration indicates that the UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot, monitor for a first CSI reference signal via the first downlink subband of the SBFD slot and a second CSI reference signal via the second downlink subband of the SBFD slot, and transmit, in accordance with the CSI reporting configuration, a CSI report indicating the first CSI for the first downlink subband of the SBFD slot and the second CSI for the second downlink subband of the SBFD slot.

In some examples of the method, apparatuses, and non-transitory computer-readable medium described herein, the CSI reporting configuration indicates that the UE may be to report CSI for an entirety of an allocated downlink bandwidth configured for the SBFD slot.

In some examples of the method, apparatuses, and non-transitory computer-readable medium described herein, the CSI reporting configuration indicates that the UE may be to report CSI for a set of multiple CSI subbands that correspond to the first downlink subband and the second downlink subband.

In some examples of the method, apparatuses, and non-transitory computer-readable medium described herein, a size of one of the set of multiple CSI subbands may be the same as a size of one of the first downlink subband or the second downlink subband.

In some examples of the method, apparatuses, and non-transitory computer-readable medium described herein, transmitting the CSI report may include operations, features, means, or instructions for transmitting the CSI report indicating a first PMI for the first downlink subband and a second PMI for the second downlink subband, where the first PMI and the second PMI may be each derived based on a same codebook configuration.

In some examples of the method, apparatuses, and non-transitory computer-readable medium described herein, transmitting the CSI report may include operations, features, means, or instructions for transmitting the CSI report indicating a CQI determined for the set of multiple downlink subbands of the SBFD slot, a first PMI determined for the entirety of the first downlink subband of the SBFD slot, and a second PMI determined for the entirety of the second downlink subband of the SBFD slot.

In some examples of the method, apparatuses, and non-transitory computer-readable medium described herein, transmitting the aperiodic CSI report may include operations, features, means, or instructions for transmitting the aperiodic CSI report indicating a CQI determined for the set of multiple downlink subbands of the SBFD slot, a first PMI determined for the entirety of the first downlink subband of the SBFD slot, and a second PMI determined for the entirety of the second downlink subband of the SBFD slot.

In some examples of the method, apparatuses, and non-transitory computer-readable medium described herein, transmitting the periodic CSI report or the semi-persistent CSI report may include operations, features, means, or instructions for transmitting a first periodic or semi-persistent CSI report indicating a first CQI determined for the set of multiple downlink subbands of the SBFD slot, a first PMI determined for the entirety of the first downlink subband of the SBFD slot, and a second PMI determined for the entirety of the second downlink subband of the SBFD slot and transmitting a second periodic or semi-persistent CSI report indicating a second CQI determined for the first downlink subband and a third CQI determined for the second downlink subband, a third PMI determined for the entirety of the first downlink subband of the SBFD slot, and a fourth PMI determined for the entirety of the second downlink subband of the SBFD slot.

In some examples of the method, apparatuses, and non-transitory computer-readable medium described herein, transmitting the CSI report may include operations, features, means, or instructions for transmitting the CSI report via an uplink shared channel, where the CSI report includes a first payload and a second payload for indicating one or more CQIs, one or more PMIs, or both in accordance with the CSI reporting configuration.

In some examples of the method, apparatuses, and non-transitory computer-readable medium described herein, the first payload indicates an average CQI, an average PMI, or both determined for the set of multiple downlink subbands of the SBFD slot, and where the second payload indicates a first PMI determined for the entirety of the first downlink subband of the SBFD slot, and a second PMI determined for the entirety of the second downlink subband of the SBFD slot.

In some examples of the method, apparatuses, and non-transitory computer-readable medium described herein, the first payload indicates a first channel quality matrix indicator determined for the entirety of the first downlink subband of the SBFD slot, and a second channel quality matrix indicator determined for the entirety of the second downlink subband of the SBFD slot, and where the second payload indicates a first PMI determined for the entirety of the first downlink subband of the SBFD slot, and a second PMI determined for the entirety of the second downlink subband of the SBFD slot.

In some examples of the method, apparatuses, and non-transitory computer-readable medium described herein, transmitting the CSI report may include operations, features, means, or instructions for transmitting the CSI report via an uplink control channel, where the CSI report includes a single payload for indicating one or more CQIs, one or more PMIs, or both in accordance with the CSI reporting configuration.

In some examples of the method, apparatuses, and non-transitory computer-readable medium described herein, the single payload indicates up to two CQIs and up to two PMIs determined for the set of multiple downlink subbands of the SBFD slot.

In some examples of the method, apparatuses, and non-transitory computer-readable medium described herein, the UE may receive a configuration message indicating a SBFD slot configuration, the SBFD slot configuration indicating that the SBFD slot comprises the plurality of downlink subbands and that the first downlink subband and the second downlink subband are non-contiguous downlink subbands.

A method for wireless communication at a network entity is described. The method may include transmitting a control message indicating a CSI reporting configuration for a SBFD slot, where the CSI reporting configuration indicates that a UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot, transmitting a first CSI reference signal via the first downlink subband of the SBFD slot and a second CSI reference signal via the second downlink subband of the SBFD slot, and receiving, in accordance with the CSI reporting configuration, a CSI report indicating the first CSI for the first downlink subband of the SBFD slot and the second CSI for the second downlink subband of the SBFD slot.

An apparatus for wireless communication at a network entity is described. The apparatus may include one or more memories, and one or more processors coupled to the one or more memories. The one or more processors may be configured to cause the apparatus to transmit a control message indicating a CSI reporting configuration for a SBFD slot, where the CSI reporting configuration indicates that a UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot, transmit a first CSI reference signal via the first downlink subband of the SBFD slot and a second CSI reference signal via the second downlink subband of the SBFD slot, and receive, in accordance with the CSI reporting configuration, a CSI report indicating the first CSI for the first downlink subband of the SBFD slot and the second CSI for the second downlink subband of the SBFD slot.

Another apparatus for wireless communication at a network entity is described. The apparatus may include means for transmitting a control message indicating a CSI reporting configuration for a SBFD slot, where the CSI reporting configuration indicates that a UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot, means for transmitting a first CSI reference signal via the first downlink subband of the SBFD slot and a second CSI reference signal via the second downlink subband of the SBFD slot, and means for receiving, in accordance with the CSI reporting configuration, a CSI report indicating the first CSI for the first downlink subband of the SBFD slot and the second CSI for the second downlink subband of the SBFD slot.

A non-transitory computer-readable medium storing code for wireless communication at a network entity is described. The code may include instructions executable by a processor to transmit a control message indicating a CSI reporting configuration for a SBFD slot, where the CSI reporting configuration indicates that a UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot, transmit a first CSI reference signal via the first downlink subband of the SBFD slot and a second CSI reference signal via the second downlink subband of the SBFD slot, and receive, in accordance with the CSI reporting configuration, a CSI report indicating the first CSI for the first downlink subband of the SBFD slot and the second CSI for the second downlink subband of the SBFD slot.

In some examples of the method, apparatuses, and non-transitory computer-readable medium described herein, the CSI reporting configuration indicates that the UE may be to report CSI for an entirety of an allocated downlink bandwidth configured for the SBFD slot.

In some examples of the method, apparatuses, and non-transitory computer-readable medium described herein, the CSI reporting configuration indicates that the UE may be to report CSI for a set of multiple CSI subbands that correspond to the first downlink subband and the second downlink subband.

In some examples of the method, apparatuses, and non-transitory computer-readable medium described herein, a size of one of the set of multiple CSI subbands may be the same as a size of one of the first downlink subband or the second downlink subband.

In some examples of the method, apparatuses, and non-transitory computer-readable medium described herein, receiving the CSI report may include operations, features, means, or instructions for receiving the CSI report indicating a first PMI for the first downlink subband and a second PMI for the second downlink subband, where the first PMI and the second PMI may be each derived based on a same codebook configuration.

In some examples of the method, apparatuses, and non-transitory computer-readable medium described herein, receiving the CSI report may include operations, features, means, or instructions for receiving the CSI report indicating a CQI determined for the set of multiple downlink subbands of the SBFD slot, a first PMI determined for the entirety of the first downlink subband of the SBFD slot, and a second PMI determined for the entirety of the second downlink subband of the SBFD slot.

In some examples of the method, apparatuses, and non-transitory computer-readable medium described herein, receiving the aperiodic CSI report may include operations, features, means, or instructions for receiving the aperiodic CSI report indicating a CQI determined for the set of multiple downlink subbands of the SBFD slot, a first PMI determined for the entirety of the first downlink subband of the SBFD slot, and a second PMI determined for the entirety of the second downlink subband of the SBFD slot.

In some examples of the method, apparatuses, and non-transitory computer-readable medium described herein, receiving the periodic CSI report or the semi-persistent CSI report may include operations, features, means, or instructions for receiving a first periodic or semi-persistent CSI report indicating a first CQI determined for the set of multiple downlink subbands of the SBFD slot, a first PMI determined for the entirety of the first downlink subband of the SBFD slot, and a second PMI determined for the entirety of the second downlink subband of the SBFD slot and receiving a second periodic or semi-persistent CSI report indicating a second CQI determined for the first downlink subband and a third CQI determined for the second downlink subband, a third PMI determined for the entirety of the first downlink subband of the SBFD slot, and a fourth PMI determined for the entirety of the second downlink subband of the SBFD slot.

In some examples of the method, apparatuses, and non-transitory computer-readable medium described herein, receiving the CSI report may include operations, features, means, or instructions for receiving the CSI report via an uplink shared channel, where the CSI report includes a first payload and a second payload for indicating one or more CQIs, one or more PMIs, or both in accordance with the CSI reporting configuration.

In some examples of the method, apparatuses, and non-transitory computer-readable medium described herein, the first payload indicates an average CQI, an average PMI, or both determined for the set of multiple downlink subbands of the SBFD slot, and where the second payload indicates a first PMI determined for the entirety of the first downlink subband of the SBFD slot, and a second PMI determined for the entirety of the second downlink subband of the SBFD slot.

In some examples of the method, apparatuses, and non-transitory computer-readable medium described herein, the first payload indicates a first channel quality matrix indicator determined for the entirety of the first downlink subband of the SBFD slot, and a second channel quality matrix indicator determined for the entirety of the second downlink subband of the SBFD slot, and where the second payload indicates a first PMI determined for the entirety of the first downlink subband of the SBFD slot, and a second PMI determined for the entirety of the second downlink subband of the SBFD slot.

In some examples of the method, apparatuses, and non-transitory computer-readable medium described herein, receiving the CSI report may include operations, features, means, or instructions for receiving the CSI report via an uplink control channel, where the CSI report includes a single payload for indicating one or more CQIs, one or more PMIs, or both in accordance with the CSI reporting configuration.

In some examples of the method, apparatuses, and non-transitory computer-readable medium described herein, the single payload indicates up to two CQIs and up to two PMIs determined for the set of multiple downlink subbands of the SBFD slot.

### BRIEF DESCRIPTION OF THE DRAWINGS

FIG. 1 shows an example of a wireless communications system that supports wideband and per-subband channel state information (CSI) reporting for subband full-duplex (SBFD) communications in accordance with one or more aspects of the present disclosure.

FIG. 2 shows an example of a wireless communications system that supports wideband and per-subband CSI reporting for SBFD communications in accordance with one or more aspects of the present disclosure.

FIG. 3 shows an example of a process flow that supports wideband and per-subband CSI reporting for SBFD communications in accordance with one or more aspects of the present disclosure.

FIGS. 4 and 5 show block diagrams of devices that support wideband and per-subband CSI reporting for SBFD communications in accordance with one or more aspects of the present disclosure.

FIG. 6 shows a block diagram of a communications manager that supports wideband and per-subband CSI reporting for SBFD communications in accordance with one or more aspects of the present disclosure.

FIG. 7 shows a diagram of a system including a device that supports wideband and per-subband CSI reporting for SBFD communications in accordance with one or more aspects of the present disclosure.

FIGS. 8 and 9 show block diagrams of devices that support wideband and per-subband CSI reporting for SBFD communications in accordance with one or more aspects of the present disclosure.

FIG. 10 shows a block diagram of a communications manager that supports wideband and per-subband CSI reporting for SBFD communications in accordance with one or more aspects of the present disclosure.

FIG. 11 shows a diagram of a system including a device that supports wideband and per-subband CSI reporting for SBFD communications in accordance with one or more aspects of the present disclosure.

FIGS. 12 through 17 show flowcharts illustrating methods that support wideband and per-subband CSI reporting for SBFD communications in accordance with one or more aspects of the present disclosure.

### DETAILED DESCRIPTION

A user equipment (UE) and a network entity may support subband full-duplex (SBFD) communications, where the UE and the network entity may transmit and receive messages at a same time and using different frequency resources (e.g., subbands). In some examples, for non-SBFD slots, the UE may report channel state information (CSI) on a subband basis. For example, the UE may generate and transmit a CSI report for specific downlink subbands of a bandwidth used for non-SBFD communications. However, in an SBFD system, the UE may support receiving a non-contiguous downlink shared channel with wideband precoding on each downlink subband of an SBFD slot, where the precoding may be different for each downlink subband of the SBFD slot. Put another way, the UE may support receiving downlink signals in SBFD slots with per-downlink subband wideband precoding (by a network entity). In such cases, the network entity may lack techniques for determining a precoding matrix indicator (PMI) for each downlink subband of the bandwidth (given that the precoding may be different for each downlink subband), which may reduce data rates and signaling capability, among other limitations.

Techniques, system, and devices described herein support wideband CSI reporting for SBFD communications, which may include wideband channel quality indicator (CQI) and PMI reporting for SBFD resources to support per-downlink subband PMI reporting. In some examples, a UE may receive a control message from a network entity indicating a CSI reporting configuration for an SBFD slot. The CSI reporting configuration may indicate that the UE is to report different CSI (including CQI and PMI values) for entire bandwidths of respective downlink subbands of the SBFD slot. For example, the CSI reporting configuration may indicate that the UE is to report first CSI for a first bandwidth of a first downlink subband, second CSI for a second bandwidth of a second downlink subband, and so on. The UE may monitor for CSI reference signals transmitted from the network entity via the respective subbands of the SBFD slot. The UE may measure the CSI reference signals to generate the CSI for each subband, and the UE may transmit a CSI report including the CSI for each subband (e.g., the first CSI and the second CSI) in accordance with the CSI reporting configuration.

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to wideband CSI reporting for SBFD communications.

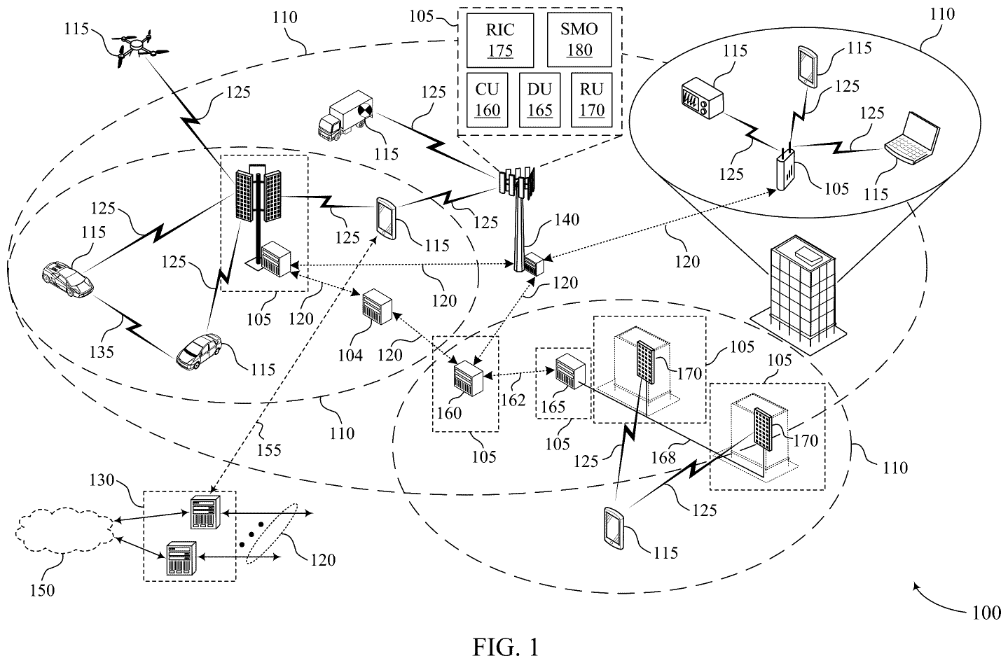

FIG. 1 shows an example of a wireless communications system 100 that supports wideband and per-subband CSI reporting for SBFD communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 (also referred to herein as network nodes 105) may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support wideband and per-subband CSI reporting for SBFD communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., reverse link transmissions, return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples, a UE 115 and a network entity 105 may support full-duplex communication, where the wireless devices may communicate uplink and downlink messages simultaneously. The UE 115 and the network entity 105 may support different types of full-duplex communication, including in-band full-duplex (IBFD) and subband FDD or SBFD (e.g., flexible duplex). When operating using IBFD communications, the UE 115 and the network entity 105 may transmit and receive at a same time and using a same frequency resource. That is, downlink and uplink transmissions may share a same IBFD time-frequency resource (fully or partially overlapping). Alternatively, using SBFD communication, the UE 115-a and the network entity 105 may transmit and receive at a same time but using different time-frequency resources. That is, a resource used for downlink may be separated from a resource used for uplink in the frequency domain (e.g., the downlink and uplink resources may be separated by a guard band).

In some examples, a UE 115 that supports half-duplex communication (e.g., receiving or transmitting messages at a given time) may communicate with a network entity 105 that supports SBFD communication. The network entity 105 may experience some cross-link interference (CLI) from other network entities in addition to self-interference. The network entity 105 may communicate with two or more half-duplex UEs 115 simultaneously using different, non-overlapping frequency subbands. For example, a first UE 115 may transmit uplink messages to the network entity 105 using an uplink subband and a second UE 115 may receive downlink messages from the network entity 105 using a downlink subband, simultaneously. In such cases, the UEs 115 may experience CLI. Alternatively, the first UE 115 may receive the downlink messages using the downlink subband and the second UE 115 may transmit the uplink messages using the uplink subband.

In some other aspects, the network entity 105 and the UEs 115 may support full-duplex operations, which may include the simultaneous transmission and reception of messages using partially or fully-overlapping uplink and downlink subbands of a bandwidth. For example, the first UE 115 may transmit and receive messages simultaneously using uplink and downlink subbands, respectively, while the second UE 115 may receive messages. In such cases, the first UE 115 may experience self-interference based on its full-duplex communication. Alternatively, the network entity 105 may support full-duplex communication and a UE 115 may support SBFD communication in a multi-TRP wireless communications system. In such cases, the network entity 105 may perform simultaneous transmission and reception of messages with multiple UEs 115 using partially or fully-overlapping uplink and downlink subbands of a bandwidth, and the UE 115 may transmit and receive the messages simultaneously using non-overlapping uplink and downlink subbands.

In some cases, SBFD-aware UEs 115 may support wideband precoding. For example, if a physical resource group (PRG) may be determined to be wideband, the UE 115 may support contiguous physical resource blocks (PRBs)) for wideband DMRS precoding or the UE 115 may support wideband precoding within each subband. In some examples, the UE 115 may support PRGs (e.g., PRGs with a size of 2 or 4 PRBs) that overlap with a boundary between subbands of an SBFD slot.

A bandwidth of a BWP may be divided into a quantity of subbands (e.g., a subband size in PRBs). In some examples, a UE 115 may measure and transmit CSI on a subband basis. As such, subband CSI feedback overhead may scale linearly with the quantity of subbands of a BWP. That is, for CSI reporting, a UE 115 may be configured (via higher-layer signaling) with one out of two possible subband sizes, where a subband may be defined as a quantity of contiguous PRBs and may depend on a total quantity of PRBs in the BWP. In such cases, subband sizes may be used such that a largest quantity of subbands does not exceed 19, and the subband sizes may be integer multiples of a PRB size (2 or 4) as well as integer multiples of a resource block group (RBG) size to avoid misalignment. For example, for a BWP of 24 to 72 PRBs, a subband size may be 4 or 8 PRBs. For a BWP of 73 to 144 PRBs, the subband size may be 8 or 16 PRBs, and for a BWP of 145 to 275 PRBs, the subband size may be 16 or 32 PRBs. The PRB size may be used for determining precoding granularity, and an RBG size may be used for determining frequency domain resources of a physical downlink shared channel (PDSCH). However, such precoding granularities may lack support for wideband precoding within each downlink subband of an SBFD slot.

In some examples, to indicate for which subbands the UE 115 is to report CSI, the network entity 105 may define a bitmap such that each bit may correspond to one of the subbands. For example, the network entity 105 may transmit an RRC configuration message including a CSI reporting configuration (e.g., CSI-ReportConfig) that indicates such a bitmap. Within the CSI reporting configuration, the network entity 105 may indicate whether CQI and PMI are to be reported on a wideband or subband basis (and whether they are to be reported together or separately). The bitmap may indicate subbands for which CSI (e.g., including CQI and PMI) is to be included in the report, which may be based on sizes of a BWP and a subband.

In SBFD systems, a UE 115 (e.g., an SBFD-aware UE) may support a non-contiguous PDSCH with wideband precoding on each downlink subband, where the downlink precoding may be different in each subband. That is, the UE 115 may support per-downlink subband wideband precoding. The network entity 105 may configure the UE 115 with wideband CQI and PMI reporting such that the UE 115 may report a single value in a CSI report. However, the network entity may lack techniques for determining a PMI for each downlink subband. That is, because a maximum subband size is limited by a corresponding BWP size, subband CQI/PMI reporting may be limited in SBFD systems. As such, techniques for enhanced wideband CQI/PMI reporting in SBFD slots to support per-downlink subband PMI reporting may improve signaling throughput and quality of communications between the UE 115 and the network entity 105.

The wireless communications system 100 may support wideband CSI reporting for SBFD communications, which may include wideband CQI and PMI reporting for SBFD resources to support per-downlink subband PMI reporting. In some examples, a UE 115 may receive a control message from a network entity 105 indicating a CSI reporting configuration for an SBFD slot. The CSI reporting configuration may indicate that the UE 115 is to report different CSI (including CQI and PMI values) for entire bandwidths of respective downlink subbands of the SBFD slot. For example, the CSI reporting configuration may indicate that the UE 115 is to report first CSI for a first bandwidth of a first downlink subband, second CSI for a second bandwidth of a second downlink subband, and so on. The UE 115 may monitor for CSI reference signals transmitted from the network entity 105 via the respective subbands of the SBFD slot. The UE 115 may measure the CSI reference signals to generate the CSI for each subband, and the UE 115 may transmit a CSI report including the CSI for each subband (e.g., the first CSI and the second CSI) in accordance with the CSI reporting configuration.

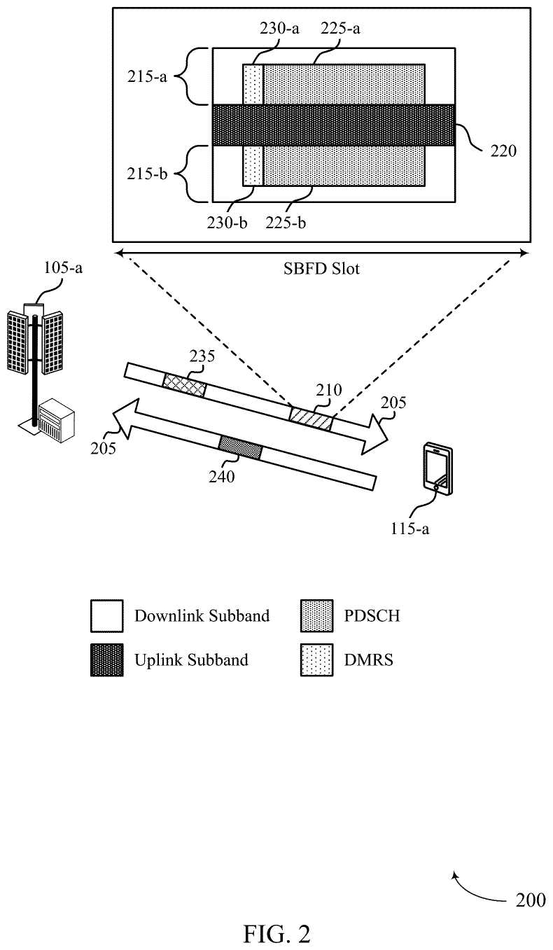

FIG. 2 shows an example of a wireless communications system 200 that supports wideband and per-subband CSI reporting for SBFD communications in accordance with one or more aspects of the present disclosure. In some examples, the wireless communications system 200 may implement aspects of the wireless communications system 100 or may be implemented by aspects of the wireless communications system 100. For example, the wireless communications system 200 may include a UE 115-a and a network node 105-a, which may be examples of corresponding devices described herein. The UE 115-a and the network node 105-a may support wideband CQI and PMI reporting for SBFD resources to support per-downlink subband PMI reporting.

The wireless communications system 200 may support communications between the UE 115-a and the network node 105-a. For example, the UE 115-a and the network node 105-a may perform uplink and downlink communications via respective communications links 205 (e.g., Uu communication links), which may be examples of communications links 125 described herein with reference to FIG. 1. In addition, the network node 105-a may support SBFD communication, which may include transmitting and receiving at a same time using non-overlapping uplink and downlink subbands of a frequency resource (e.g., on a subband-basis). In such cases, the UE 115-a may support half-duplex communication (e.g., transmitting or receiving at a same time using downlink or uplink subbands), and as such, the UE 115-a may transmit uplink communications to the network node 105-a or receive downlink communications from the network node 105-a at a given time. If the network node 105-a also wirelessly communicates with a second UE, the network node 105-a may receive uplink messages from the UE 115-a and transmit downlink messages to the second UE simultaneously using different frequency subbands (e.g., an uplink subband for the UE 115-a and a downlink subband for the second UE).

In some examples, the UE 115-a may receive a configuration message indicating a SBFD slot configuration for one or more slots. For example, the UE 115-a may receive a configuration message indicating that a first slot is an SBFD slot. The SFBD slot may include a downlink subband 215-a, an uplink subband 220, and a downlink subband 215-b. In some examples, the SBFD slot configuration may indicate that one or more downlink subbands (e.g., the downlink subband 215-a, the downlink subband 215-b) are non-contiguous downlink subbands.

The UE 115-a may receive a control message 210 from the network node 105-a, the control message 210 indicating a CSI reporting configuration for an SBFD slot. The CSI reporting configuration may indicate that the UE 115-a is to report per-downlink subband CSI. That is, the UE 115-a may support wideband CQI and PMI reporting, which may be restricted to each downlink subband. For example, the CSI reporting configuration may indicate that the UE 115-a is to report first CSI determined for an entirety of a first bandwidth of the downlink subband 215-a of the SBFD slot and second CSI determined for an entirety of a second bandwidth of the downlink subband 215-b of the SBFD slot. As described herein, the CSI determined for an entirety of a bandwidth of a downlink subband 215 may be referred to as wideband CSI for that downlink subband 215. That is, the CSI reporting configuration may indicate that the UE 115-a is to report wideband CSI (e.g., wideband CQI, wideband PMI) for the respective downlink subbands 215 of the SBFD slot.

In some examples, the control message 210 may include an explicit indication (e.g., cqi/pmiformatIndicator) that the UE 115-a is to report CSI per downlink subband. For example, the CSI reporting configuration may indicate different CSI reporting options (e.g., wideband, subband, wideband-perDL-subband), where a wideband-perDL-subband reporting option may indicate that the UE 115-a is to report the CSI per downlink subband. Alternatively, or additionally, the network node 105-a may configure the UE 115-a with wideband CSI reporting in SBFD, which the UE 115-a may interpret as per-downlink subband CSI reporting (instead of wideband reporting for an entire SBFD slot). That is, the control message 210 may indicate that the UE 115-a is to report CSI for the entirety of an allocated downlink bandwidth configured for the SBFD slot (e.g., wideband CQI/PMI), which may be an implicit indication that the UE 115-a may interpret as per-downlink subband CSI reporting based on the slot being an SBFD slot.

Alternatively, or additionally, the control message 210 may indicate that the UE 115-a is to report CSI per downlink subband based on a CSI reporting granularity (e.g., csi-ReportingBand granularity). As described herein with reference to FIG. 1, there may be two possible subband sizes for each BWP size. To indicate the CSI reporting configuration, the network node 105-a may include another option that matches a size of a downlink subband 215, which may enable subband reporting for SBFD slots. That is, a csi-ReportingBand granularity may indicate two CSI subbands and thus, two downlink subbands 215. In such cases, the control message 210 may indicate that the UE 115-a is to report CSI for a set of multiple CSI subbands that correspond to (e.g., match) the downlink subbands 215. The CSI subband size may depend on a downlink subband size. For example, the CSI subband size may be equal to an intersection or overlap between one downlink subband and the corresponding BWP (e.g., a size of one of the CSI subbands may be the same as a size of one of the downlink subbands 215).

The UE 115-a may monitor for CSI reference signals 235 via the downlink subbands 215, which the UE 115-a may measure to obtain CSI. For example, the UE 115-a may monitor for a first CSI reference signal 235 via the downlink subband 215-a and a second CSI reference signal 235 via the downlink subband 215-b, and the UE 115-a may measure first CSI and second CSI for the downlink subband 215-a and the downlink subband 215-b, respectively.

In some examples, the UE 115-a may transmit a CSI report 240 in accordance with the CSI reporting configuration. The CSI report 240 may indicate the first CSI for the downlink subband 215-a and the second CSI for the downlink subband 215-b, and the CSI may include at least CQIs, or PMIs, or a combination thereof. In the example of FIG. 2, the UE 115-a may be scheduled with PDSCHs 225 across two downlink subbands 215 with a same MCS (and thus a same, single CQI) and different PMIs for each downlink subband 215. For example, the network node 105-a may schedule a PDSCH 225-a in the downlink subband 215-a and a PDSCH 225-b in the downlink subband 215-b of the SBFD slot. Accordingly, as described herein with reference to Table 1, the UE 115-a may report a single wideband CQI (e.g., CQI) and different wideband PMIs for the downlink subbands 215 (e.g., PMI_1 for the downlink subband 215-a, PMI_2 for the downlink subband 215-b). The PDSCH 225-a may correspond to a DMRS 230-a and the PDSCH 225-b may correspond to a DMRS 230-b.

TABLE 1

| CQI - wideband | PMI - wideband |
|---|---|
| CQI | PMI_1 |
| | PMI_2 |

Alternatively, or additionally, the UE 115-a may be scheduled in either downlink subband 215. Thus, the UE 115-a may report different wideband CQIs and different wideband PMIs for each downlink subband 215 as described herein with reference to Table 2 (e.g., CQI_1 and PMI_1 for the downlink subband 215-a, CQI_2 and PMI_2 for the downlink subband 215-b). As such, each CSI subband may map to a downlink subband 215. Based on the PMIs reported for each downlink subband 215, the network node 105-a may determine which precoding to use for subsequent transmissions.

TABLE 2

| CQI - wideband | PMI - wideband |
|---|---|
| CQI_1 | PMI_1 |
| CQI_2 | PMI_2 |

In some examples, the UE 115-a may transmit the CSI report 240 indicating a first PMI for the downlink subband 215-a and a second PMI for the downlink subband 215-b, and the UE 115-a may derive the reported PMIs based on a same codebook configuration. That is, a component (e.g., W1 component) of a codebook is assumed to be common over the downlink subbands 215.

In some cases, the CSI report configuration may indicate that the UE 115-a is to report both wideband CSI and subband CSI (each including CQIs, PMIs, or both) for the SBFD slot. For example, when the network node 105-a configures both wideband CQI and wideband PMI reporting, the UE 115-a may report a wideband CQI for an entirety of the CSI reporting bands (e.g., both downlink subbands 215 of the SBFD slot) and two wideband PMIs, one for each downlink subband 215. In such cases, if the network node 105-a configures wideband CQI and wideband PMI reporting for the SBFD slot, the UE 115-a may include three values (one CQI value and two PMIs values) in the CSI report 240. For example, the CSI report 240 may indicate a CQI determined for all of the downlink subbands 215 of the SBFD slot, a first PMI determined for an entirety of the downlink subband 215-a, and a second PMI determined for an entirety of the downlink subband 215-b (e.g., a wideband CQI and wideband PMIs). Alternatively, if the network node 105-a configures wideband CQI and wideband PMI reporting for a non-SBFD slot (e.g., a downlink slot), the UE 115-a may include a single CQI/PMI value in the CSI report 240.

In some aspects, what CSI the UE 115-a includes in the CSI report 240 may depend on whether the UE 115-a transmits the CSI report 240 aperiodically, semi-persistently, or periodically. If the CSI report 240 is aperiodic, the UE 115-a may include wideband and per-downlink subband CQIs and PMIs. For example, the aperiodic CSI report may indicate a CQI determined for all of the downlink subbands 215 of the SBFD slot, a first PMI determined for an entirety of the downlink subband 215-a, and a second PMI determined for an entirety of the downlink subband 215-b. Alternatively, if the CSI report 240 is a semi-persistent CSI report or a periodic CSI report, the UE 115-a may alternate between reporting wideband CQIs and wideband PMIs and per-downlink subband CQIs and per-downlink subband PMIs. For example, the UE 115-a may transmit a first semi-persistent or periodic CSI report that indicates a first CQI determined for all of the downlink subbands 215 of the SBFD slot, a first PMI determined for an entirety of the downlink subband 215-a, and a second PMI determined for an entirety of the downlink subband 215-b (e.g., wideband CQI, wideband PMIs). In addition, the UE 115-a may transmit a second semi-persistent or periodic CSI report that indicates a second CQI determined for the downlink subband 215-a, a third CQI determined for the downlink subband 215-b, a third PMI determined for an entirety of the downlink subband 215-a, and a fourth PMI determined for an entirety of the downlink subband 215-b.

In some examples, the UE 115-a may multiplex wideband and subband CSI in a same CSI report. The UE 115-a may use an existing report structure for subband reporting to report per-downlink subband CSI, or the UE 115-a may use a one or two-part payload design to enable the per-downlink subband CSI reporting. In some examples, the payload design of the CSI report 240 may differ depending on whether the UE 115-a transmits the CSI report 240 via a physical uplink shared channel (PUSCH) or a physical uplink control channel (PUCCH). For example, if the UE 115-a transmits the CSI report 240 via a PUSCH, the CSI report 240 may include a first payload and a second payload (e.g., a two-part payload) for indicating one or more CQIs, one or more PMIs, or both in accordance with the CSI reporting configuration. In some cases, the first payload (e.g., CSI part 1) may include an average CQI, an average PMI, or both (determined for all of the downlink subbands 215 of the SBFD slot) and the second payload (e.g., CSI part 2) may include a first PMI determined for an entirety of the downlink subband 215-a, and a second PMI determined for an entirety of the downlink subband 215-b. The UE 115-a may use the first and second payloads in this way when reporting CSI for non-SBFD symbols.

Alternatively, or additionally, the UE 115-a may use the two payloads (e.g., two transport blocks (TBs)) to indicate two CQIs and two PMIs for the downlink subbands 215. For example, the first payload (e.g., CSI part 1) may indicate a first CQI determined for the entirety of the downlink subband 215-a and a second CQI determined for the entirety of the downlink subband 215-b, and the second payload (e.g., CSI part 2) may indicate a first PMI determined for the entirety of the downlink subband 215-a and a second PMI determined for the entirety of the downlink subband 215-b (e.g., wideband CQI and PMI).

If the UE 115-a transmits the CSI report 240 via a PUCCH, the CSI report 240 may include a single payload (e.g., a one-part payload) for indicating one or more CQIs, one or more PMIs, or both in accordance with the CSI reporting configuration. The single payload (e.g., CSI part 1) may include up to two CQIs and up to two PMIs corresponding to the downlink subbands 215. For example, the single payload may include a first CQI and a first PMI determined for the downlink subband 215-a in addition to a second CQI and a second PMI determined for the downlink subband 215-b.

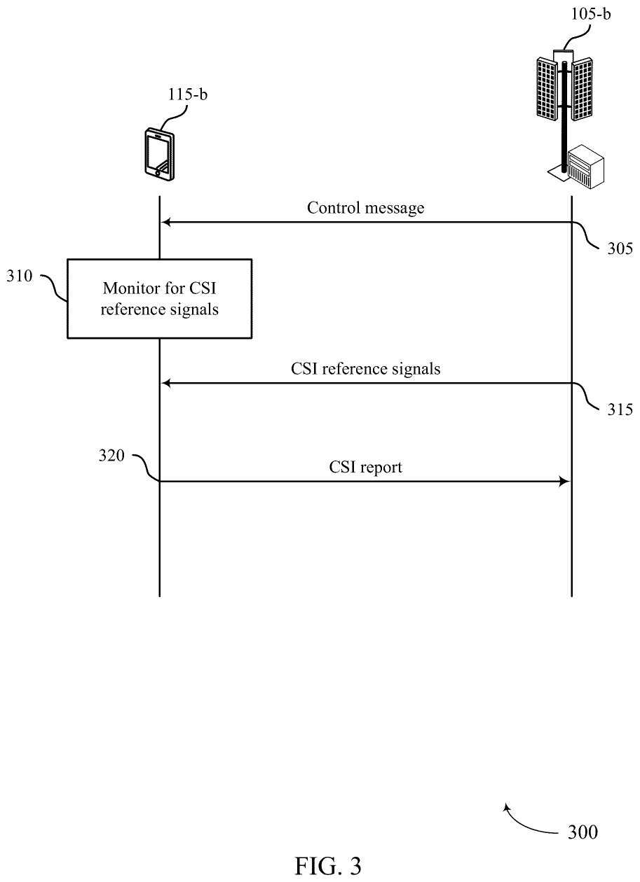

FIG. 3 shows an example of a process flow 300 that supports wideband and per-subband CSI reporting for SBFD communications in accordance with one or more aspects of the present disclosure. The process flow 300 may implement aspects of wireless communications systems 100 and 200, or may be implemented by aspects of the wireless communications system 100 and 200. For example, the process flow 300 may illustrate operations between a UE 115-b and a network node 105-b, which may be examples of corresponding devices described herein. In the following description of the process flow 300, the operations between the UE 115-b and the network node 105-b may be transmitted in a different order than the example order shown, or the operations performed by the UE 115-b and the network node 105-b may be performed in different orders or at different times. Some operations may also be omitted from the process flow 300, and other operations may be added to the process flow 300.

At 305, the UE 115-b may receive, from the network node 105-b, a control message indicating a CSI reporting configuration for a SBFD slot (e.g., an SBFD slot indicated by an SBFD slot configuration from the network node 105-b), where the CSI reporting configuration indicates that the UE 115-b is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot. In some examples, the SBFD slot configuration may indicate that the first downlink subband and the second downlink subband are non-contiguous. The CSI determined for the entirety of the bandwidths of the downlink subbands may include wideband CQIs and PMIs. In some cases, the CSI reporting configuration may include an explicit (e.g., cqi/pmiformatIndicator) or implicit indication that the UE 115-b is to report the first and second CSI.

At 310, the UE 115-b may monitor for a first CSI reference signal via the first downlink subband of the SBFD slot and a second CSI reference signal via the second downlink subband of the SBFD slot.

At 315, the UE 115-b may receive, from the network node 105-b, the first CSI reference signal via the first downlink subband of the SBFD slot and the second CSI reference signal via the second downlink subband of the SBFD slot. In some examples, the UE 115-b may measure the first CSI reference signal and the second CSI reference signal to obtain CSI for a CSI report.

At 320, the UE 115-b may transmit, to the network node 105-b and in accordance with the CSI reporting configuration, the CSI report indicating the first CSI for the first downlink subband of the SBFD slot and the second CSI for the second downlink subband of the SBFD slot. In some examples, the CSI report may include some combination of wideband and per-subband CQIs and PMIs. For example, the CSI report may indicate a CQI determined for the set of multiple downlink subbands of the SBFD slot, a first precoding matrix indicator determined for the entirety of the first downlink subband of the SBFD slot, and a second precoding matrix indicator determined for the entirety of the second downlink subband of the SBFD slot. In some examples, what the UE 115-b includes in the CSI report may depend on whether the CSI report is aperiodic, semi-persistent, or periodic. Additionally, the CSI report may include a single payload or two payloads to indicate one or more CQIs, one or more PMIs, or both.

In some examples, the network node 105-b may use the CSI report for one or more subsequent transmissions. For example, the network node 105-b may use information included in the CSI report (e.g., the PMIs, the CQIs) to select a preferred precoder matrix for transmission via one or more of the set of multiple downlink subbands (e.g., or for the entirety of the first bandwidth). Additionally, or alternatively, the network node 105-b may use information included in the CSI report (e.g., the PMIs, the CQIs) to select a modulation and coding scheme (MCS) for transmission via one or more of the set of multiple downlink subbands (e.g., or for the entirety of the first bandwidth).

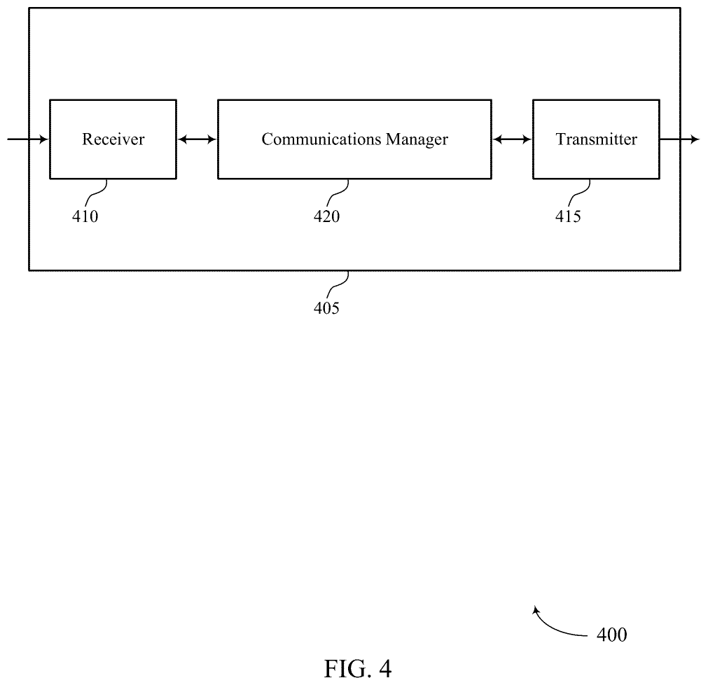

FIG. 4 shows a block diagram 400 of a device 405 that supports wideband and per-subband CSI reporting for SBFD communications in accordance with one or more aspects of the present disclosure. The device 405 may be an example of aspects of a UE 115 as described herein. The device 405 may include a receiver 410, a transmitter 415, and a communications manager 420. The device 405 may also include one or more processors, memory coupled with the one or more processors, and instructions stored in the memory that are executable by the one or more processors to enable the one or more processors to perform the CSI reporting features discussed herein. Each of these components may be in communication with one another (e.g., via one or more buses).

The receiver 410 may provide a means for receiving information such as packets, user data, control information, or any combination thereof associated with various information channels (e.g., control channels, data channels, information channels related to wideband CSI reporting for SBFD communications). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to wideband CSI reporting for SBFD communications). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of wideband and per-subband CSI reporting for SBFD communications as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

For example, the communications manager 420 is capable of, configured to, or operable to support a means for receiving a control message indicating a CSI reporting configuration for a SBFD slot, where the CSI reporting configuration indicates that the UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot. The communications manager 420 is capable of, configured to, or operable to support a means for monitoring for a first CSI reference signal via the first downlink subband of the SBFD slot and a second CSI reference signal via the second downlink subband of the SBFD slot. The communications manager 420 is capable of, configured to, or operable to support a means for transmitting, in accordance with the CSI reporting configuration, a CSI report indicating the first CSI for the first downlink subband of the SBFD slot and the second CSI for the second downlink subband of the SBFD slot.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for wideband and per-downlink subband CSI reporting for SBFD communications, which may improve communication reliability, improve spectral efficiency and data rates, improve coordination between wireless devices, and improve utilization of processing capability.

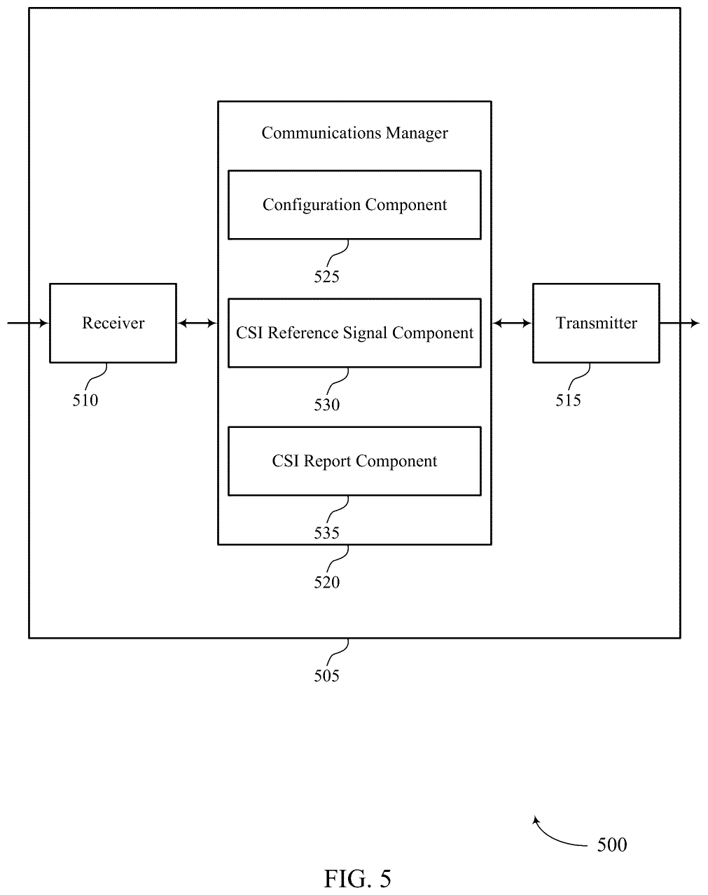

FIG. 5 shows a block diagram 500 of a device 505 that supports wideband and per-subband CSI reporting for SBFD communications in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to wideband CSI reporting for SBFD communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to wideband CSI reporting for SBFD communications). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of wideband and per-subband CSI reporting for SBFD communications as described herein. For example, the communications manager 520 may include a configuration component 525, a CSI reference signal component 530, a CSI report component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The configuration component 525 is capable of, configured to, or operable to support a means for receiving a control message indicating a CSI reporting configuration for a SBFD slot, where the CSI reporting configuration indicates that the UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot. The CSI reference signal component 530 is capable of, configured to, or operable to support a means for monitoring for a first CSI reference signal via the first downlink subband of the SBFD slot and a second CSI reference signal via the second downlink subband of the SBFD slot. The CSI report component 535 is capable of, configured to, or operable to support a means for transmitting, in accordance with the CSI reporting configuration, a CSI report indicating the first CSI for the first downlink subband of the SBFD slot and the second CSI for the second downlink subband of the SBFD slot.

In some cases, the configuration component 525, the CSI reference signal component 530, and the CSI report component 535 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the configuration component 525, the CSI reference signal component 530, and the CSI report component 535 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

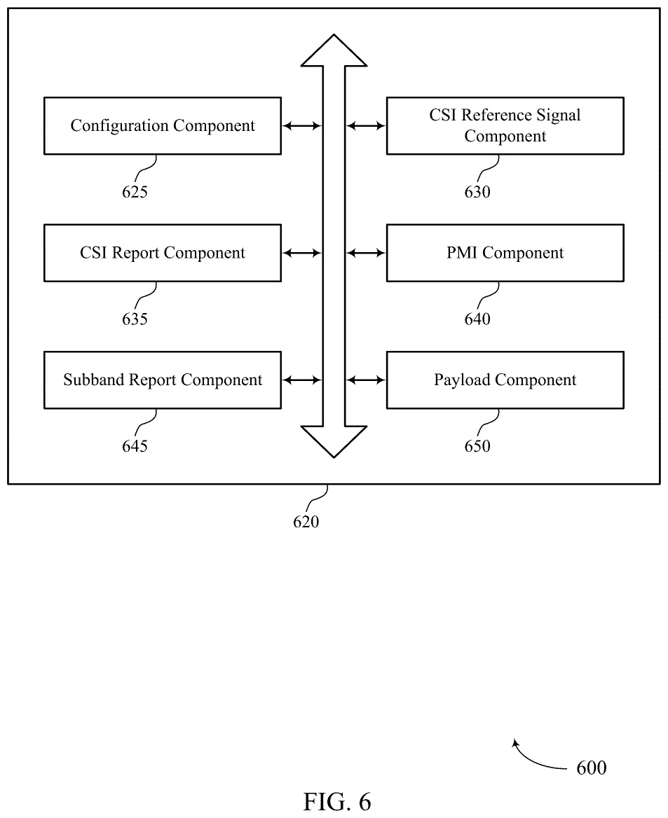

FIG. 6 shows a block diagram 600 of a communications manager 620 that supports wideband and per-subband CSI reporting for SBFD communications in accordance with one or more aspects of the present disclosure. The communications manager 620 may be an example of aspects of a communications manager 420, a communications manager 520, or both, as described herein. The communications manager 620, or various components thereof, may be an example of means for performing various aspects of wideband and per-subband CSI reporting for SBFD communications as described herein. For example, the communications manager 620 may include a configuration component 625, a CSI reference signal component 630, a CSI report component 635, a PMI component 640, a subband report component 645, a payload component 650, or any combination thereof. Each of these components may communicate, directly or indirectly, with one another (e.g., via one or more buses).

The configuration component 625 is capable of, configured to, or operable to support a means for receiving a control message indicating a CSI reporting configuration for a SBFD slot, where the CSI reporting configuration indicates that the UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot. The configuration component 625 is capable of, configured to, or operable to support a means for receiving a configuration message indicating a SBFD slot configuration, the SBFD slot configuration indicating that the SBFD slot comprises the plurality of downlink subbands and that the first downlink subband and the second downlink subband are non-contiguous downlink subbands. The CSI reference signal component 630 is capable of, configured to, or operable to support a means for monitoring for a first CSI reference signal via the first downlink subband of the SBFD slot and a second CSI reference signal via the second downlink subband of the SBFD slot. The CSI report component 635 is capable of, configured to, or operable to support a means for transmitting, in accordance with the CSI reporting configuration, a CSI report indicating the first CSI for the first downlink subband of the SBFD slot and the second CSI for the second downlink subband of the SBFD slot. In some examples, the control message indicates that the UE is to report CSI for an entirety of an allocated downlink bandwidth configured for the SBFD slot.

In some examples, the control message indicates that the UE is to report CSI for a set of multiple CSI subbands that correspond to the first downlink subband and the second downlink subband. In some examples, a size of one of the set of multiple CSI subbands is the same as a size of one of the first downlink subband or the second downlink subband.

In some examples, to support transmitting the CSI report, the PMI component 640 is capable of, configured to, or operable to support a means for transmitting the CSI report indicating a first precoding matrix indicator for the first downlink subband and a second precoding matrix indicator for the second downlink subband, where the first precoding matrix indicator and the second precoding matrix indicator are each derived based on a same codebook configuration.

In some examples, to support transmitting the CSI report, the subband report component 645 is capable of, configured to, or operable to support a means for transmitting the CSI report indicating a CQI determined for the set of multiple downlink subbands of the SBFD slot, a first PMI determined for the entirety of the first downlink subband of the SBFD slot, and a second PMI determined for the entirety of the second downlink subband of the SBFD slot.

In some examples, to support transmitting the aperiodic CSI report, the subband report component 645 is capable of, configured to, or operable to support a means for transmitting the aperiodic CSI report indicating a CQI determined for the set of multiple downlink subbands of the SBFD slot, a first PMI determined for the entirety of the first downlink subband of the SBFD slot, and a second PMI determined for the entirety of the second downlink subband of the SBFD slot.

In some examples, to support transmitting the periodic CSI report or the semi-persistent CSI report, the subband report component 645 is capable of, configured to, or operable to support a means for transmitting a first periodic or semi-persistent CSI report indicating a first CQI determined for the set of multiple downlink subbands of the SBFD slot, a first PMI determined for the entirety of the first downlink subband of the SBFD slot, and a second PMI determined for the entirety of the second downlink subband of the SBFD slot. In some examples, to support transmitting the periodic CSI report or the semi-persistent CSI report, the subband report component 645 is capable of, configured to, or operable to support a means for transmitting a second periodic or semi-persistent CSI report indicating a second CQI determined for the first downlink subband and a third CQI determined for the second downlink subband, a third PMI determined for the entirety of the first downlink subband of the SBFD slot, and a fourth PMI determined for the entirety of the second downlink subband of the SBFD slot.

In some examples, to support transmitting the CSI report, the payload component 650 is capable of, configured to, or operable to support a means for transmitting the CSI report via an uplink shared channel, where the CSI report includes a first payload and a second payload for indicating one or more CQIs, one or more PMIs, or both in accordance with the CSI reporting configuration.

In some examples, the first payload indicates an average CQI, an average PMI, or both determined for the set of multiple downlink subbands of the SBFD slot, and where the second payload indicates a first PMI determined for the entirety of the first downlink subband of the SBFD slot, and a second PMI determined for the entirety of the second downlink subband of the SBFD slot.

In some examples, the first payload indicates a first channel quality matrix indicator determined for the entirety of the first downlink subband of the SBFD slot, and a second channel quality matrix indicator determined for the entirety of the second downlink subband of the SBFD slot, and where the second payload indicates a first PMI determined for the entirety of the first downlink subband of the SBFD slot, and a second PMI determined for the entirety of the second downlink subband of the SBFD slot.

In some examples, to support transmitting the CSI report, the payload component 650 is capable of, configured to, or operable to support a means for transmitting the CSI report via an uplink control channel, where the CSI report includes a single payload for indicating one or more CQIs, one or more PMIs, or both in accordance with the CSI reporting configuration.

In some examples, the single payload indicates up to two CQIs and up to two PMIs determined for the set of multiple downlink subbands of the SBFD slot.

In some cases, the configuration component 625, the CSI reference signal component 630, the CSI report component 635, the PMI component 640, the subband report component 645, and the payload component 650 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the configuration component 625, the CSI reference signal component 630, the CSI report component 635, the PMI component 640, the subband report component 645, and the payload component 650 discussed herein.

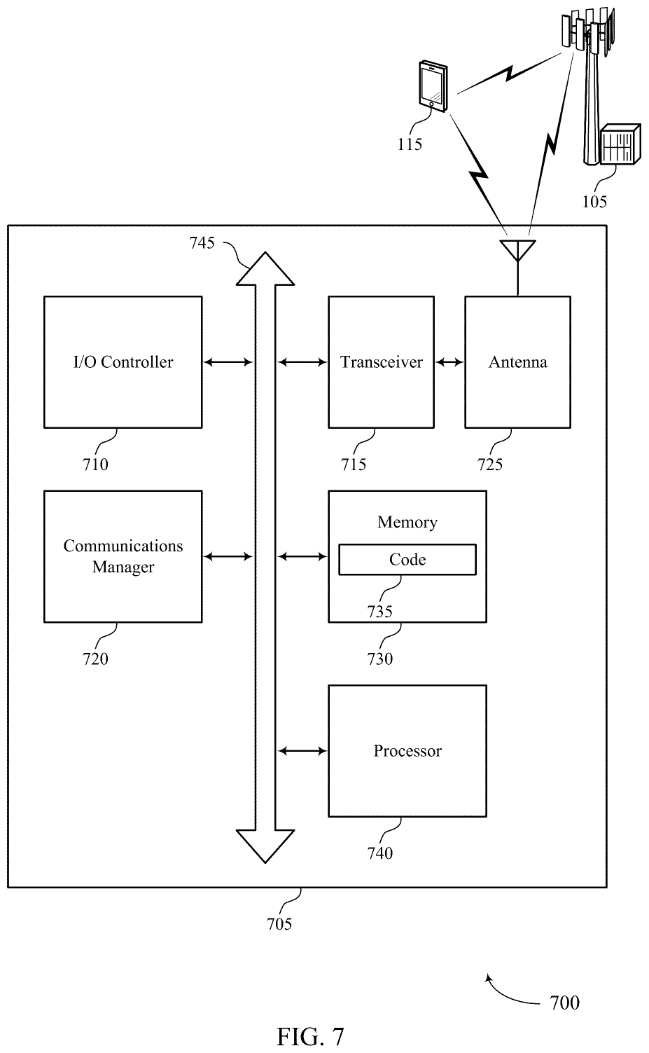

FIG. 7 shows a diagram of a system 700 including a device 705 that supports wideband and per-subband CSI reporting for SBFD communications in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting wideband CSI reporting for SBFD communications). For example, the device 705 or a component of the device 705 may include a processor 740 and memory 730 coupled with or to the processor 740, the processor 740 and memory 730 configured to perform various functions described herein.

For example, the communications manager 720 is capable of, configured to, or operable to support a means for receiving a control message indicating a CSI reporting configuration for a SBFD slot, where the CSI reporting configuration indicates that the UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot. The communications manager 720 is capable of, configured to, or operable to support a means for monitoring for a first CSI reference signal via the first downlink subband of the SBFD slot and a second CSI reference signal via the second downlink subband of the SBFD slot. The communications manager 720 is capable of, configured to, or operable to support a means for transmitting, in accordance with the CSI reporting configuration, a CSI report indicating the first CSI for the first downlink subband of the SBFD slot and the second CSI for the second downlink subband of the SBFD slot. The communications manager 720 is capable of, configured to, or operable to support a means for receiving a configuration message indicating a SBFD slot configuration, the SBFD slot configuration indicating that the SBFD slot comprises the plurality of downlink subbands and that the first downlink subband and the second downlink subband are non-contiguous downlink subbands.

By including or configuring the communications manager 720 in accordance with examples as described herein, the device 705 may support techniques for wideband and per-downlink subband CSI reporting for SBFD communications, which may improve communication reliability, improve spectral efficiency and data rates, improve coordination between wireless devices, and improve utilization of processing capability.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of wideband and per-subband CSI reporting for SBFD communications as described herein, or the processor 740 and the memory 730 may be otherwise configured to perform or support such operations.

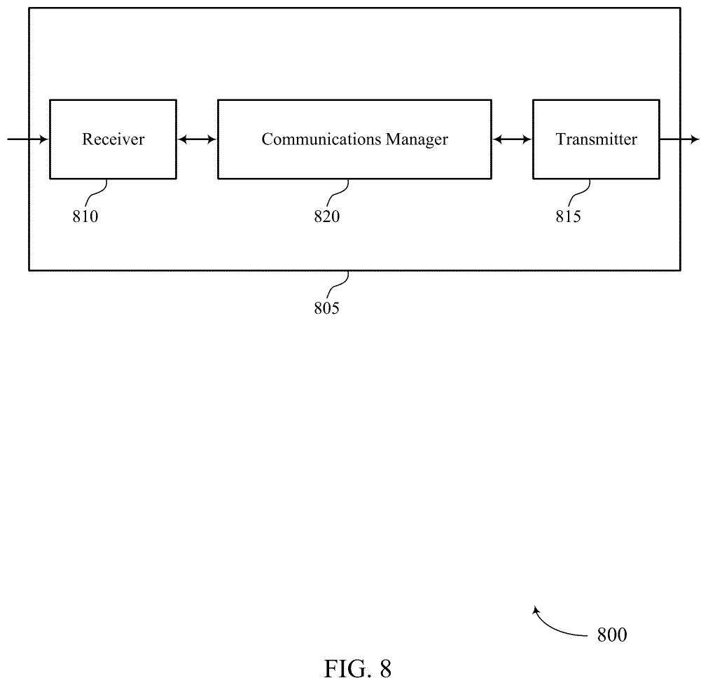

FIG. 8 shows a block diagram 800 of a device 805 that supports wideband and per-subband CSI reporting for SBFD communications in accordance with one or more aspects of the present disclosure. The device 805 may be an example of aspects of a network node 105 as described herein. The device 805 may include a receiver 810, a transmitter 815, and a communications manager 820. The device 805 may also include one or more processors, memory coupled with the one or more processors, and instructions stored in the memory that are executable by the one or more processors to enable the one or more processors to perform the CSI reporting features discussed herein. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of wideband and per-subband CSI reporting for SBFD communications as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

For example, the communications manager 820 is capable of, configured to, or operable to support a means for transmitting a control message indicating a CSI reporting configuration for a SBFD slot, where the CSI reporting configuration indicates that a UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot. The communications manager 820 is capable of, configured to, or operable to support a means for transmitting a first CSI reference signal via the first downlink subband of the SBFD slot and a second CSI reference signal via the second downlink subband of the SBFD slot. The communications manager 820 is capable of, configured to, or operable to support a means for receiving, in accordance with the CSI reporting configuration, a CSI report indicating the first CSI for the first downlink subband of the SBFD slot and the second CSI for the second downlink subband of the SBFD slot.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for wideband and per-downlink subband CSI reporting for SBFD communications, which may improve communication reliability, improve spectral efficiency and data rates, improve coordination between wireless devices, and improve utilization of processing capability.

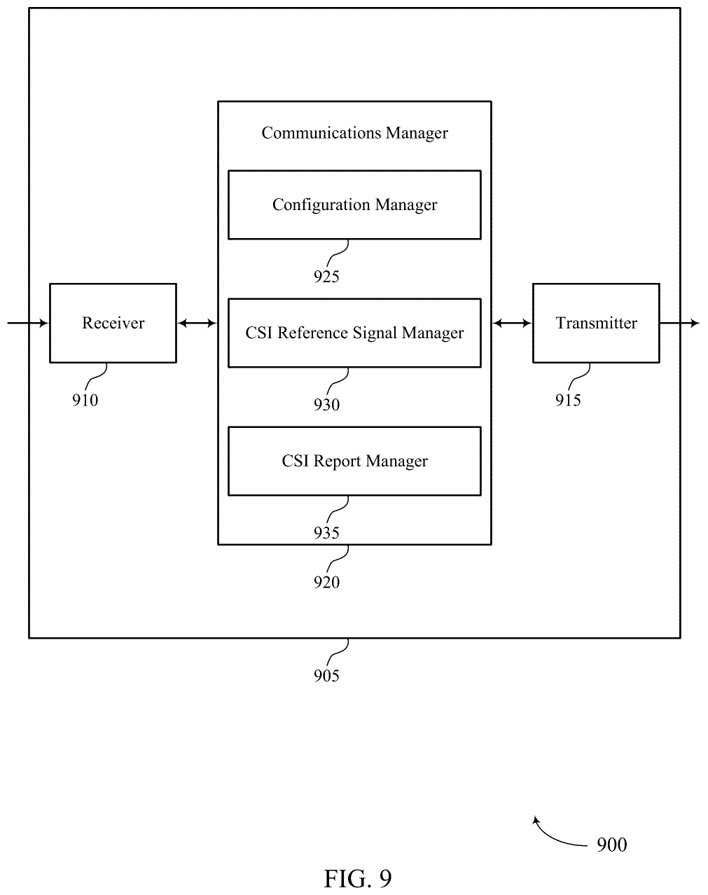

FIG. 9 shows a block diagram 900 of a device 905 that supports wideband and per-subband CSI reporting for SBFD communications in accordance with one or more aspects of the present disclosure. The device 905 may be an example of aspects of a device 805 or a network node 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of wideband and per-subband CSI reporting for SBFD communications as described herein. For example, the communications manager 920 may include a configuration manager 925, a CSI reference signal manager 930, a CSI report manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The configuration manager 925 is capable of, configured to, or operable to support a means for transmitting a control message indicating a CSI reporting configuration for a SBFD slot, where the CSI reporting configuration indicates that a UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot. The CSI reference signal manager 930 is capable of, configured to, or operable to support a means for transmitting a first CSI reference signal via the first downlink subband of the SBFD slot and a second CSI reference signal via the second downlink subband of the SBFD slot. The CSI report manager 935 is capable of, configured to, or operable to support a means for receiving, in accordance with the CSI reporting configuration, a CSI report indicating the first CSI for the first downlink subband of the SBFD slot and the second CSI for the second downlink subband of the SBFD slot.

In some cases, the configuration manager 925, the CSI reference signal manager 930, and the CSI report manager 935 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the configuration manager 925, the CSI reference signal manager 930, and the CSI report manager 935 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

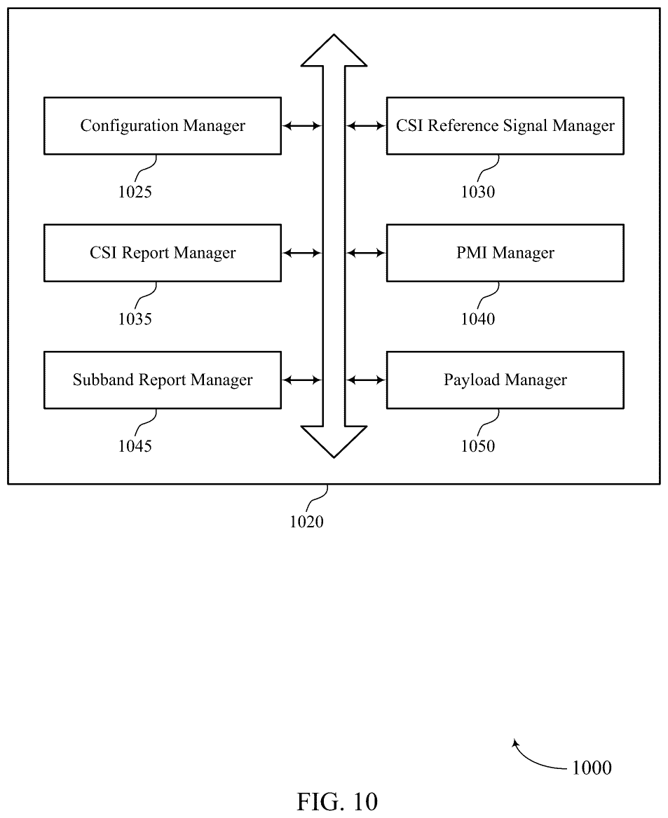

FIG. 10 shows a block diagram 1000 of a communications manager 1020 that supports wideband and per-subband CSI reporting for SBFD communications in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of wideband and per-subband CSI reporting for SBFD communications as described herein. For example, the communications manager 1020 may include a configuration manager 1025, a CSI reference signal manager 1030, a CSI report manager 1035, a PMI manager 1040, a subband report manager 1045, a payload manager 1050, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network node 105, between devices, components, or virtualized components associated with a network node 105), or any combination thereof.

The configuration manager 1025 is capable of, configured to, or operable to support a means for transmitting a control message indicating a CSI reporting configuration for a SBFD slot, where the CSI reporting configuration indicates that a UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot. The CSI reference signal manager 1030 is capable of, configured to, or operable to support a means for transmitting a first CSI reference signal via the first downlink subband of the SBFD slot and a second CSI reference signal via the second downlink subband of the SBFD slot. The CSI report manager 1035 is capable of, configured to, or operable to support a means for receiving, in accordance with the CSI reporting configuration, a CSI report indicating the first CSI for the first downlink subband of the SBFD slot and the second CSI for the second downlink subband of the SBFD slot.

In some examples, the CSI reporting configuration indicates that the UE is to report CSI for an entirety of an allocated downlink bandwidth configured for the SBFD slot. In some examples, the CSI reporting configuration indicates that the UE is to report CSI for a set of multiple CSI subbands that correspond to the first downlink subband and the second downlink subband. In some examples, a size of one of the set of multiple CSI subbands is the same as a size of one of the first downlink subband or the second downlink subband.

In some examples, to support receiving the CSI report, the PMI manager 1040 is capable of, configured to, or operable to support a means for receiving the CSI report indicating a first PMI for the first downlink subband and a second PMI for the second downlink subband, where the first PMI and the second PMI are each derived based on a same codebook configuration.

In some examples, to support receiving the CSI report, the subband report manager 1045 is capable of, configured to, or operable to support a means for receiving the CSI report indicating a CQI determined for the set of multiple downlink subbands of the SBFD slot, a first PMI determined for the entirety of the first downlink subband of the SBFD slot, and a second PMI determined for the entirety of the second downlink subband of the SBFD slot.

In some examples, to support receiving the aperiodic CSI report, the subband report manager 1045 is capable of, configured to, or operable to support a means for receiving the aperiodic CSI report indicating a CQI determined for the set of multiple downlink subbands of the SBFD slot, a first PMI determined for the entirety of the first downlink subband of the SBFD slot, and a second PMI determined for the entirety of the second downlink subband of the SBFD slot.

In some examples, to support receiving the periodic CSI report or the semi-persistent CSI report, the subband report manager 1045 is capable of, configured to, or operable to support a means for receiving a first periodic or semi-persistent CSI report indicating a first CQI determined for the set of multiple downlink subbands of the SBFD slot, a first PMI determined for the entirety of the first downlink subband of the SBFD slot, and a second PMI determined for the entirety of the second downlink subband of the SBFD slot. In some examples, to support receiving the periodic CSI report or the semi-persistent CSI report, the subband report manager 1045 is capable of, configured to, or operable to support a means for receiving a second periodic or semi-persistent CSI report indicating a second CQI determined for the first downlink subband and a third CQI determined for the second downlink subband, a third PMI determined for the entirety of the first downlink subband of the SBFD slot, and a fourth PMI determined for the entirety of the second downlink subband of the SBFD slot.

In some examples, to support receiving the CSI report, the payload manager 1050 is capable of, configured to, or operable to support a means for receiving the CSI report via an uplink shared channel, where the CSI report includes a first payload and a second payload for indicating one or more CQIs, one or more PMIs, or both in accordance with the CSI reporting configuration.

In some examples, the first payload indicates an average CQI, an average PMI, or both determined for the set of multiple downlink subbands of the SBFD slot, and where the second payload indicates a first PMI determined for the entirety of the first downlink subband of the SBFD slot, and a second PMI determined for the entirety of the second downlink subband of the SBFD slot.

In some examples, the first payload indicates a first channel quality matrix indicator determined for the entirety of the first downlink subband of the SBFD slot, and a second channel quality matrix indicator determined for the entirety of the second downlink subband of the SBFD slot, and where the second payload indicates a first PMI determined for the entirety of the first downlink subband of the SBFD slot, and a second PMI determined for the entirety of the second downlink subband of the SBFD slot.

In some examples, to support receiving the CSI report, the payload manager 1050 is capable of, configured to, or operable to support a means for receiving the CSI report via an uplink control channel, where the CSI report includes a single payload for indicating one or more CQIs, one or more PMIs, or both in accordance with the CSI reporting configuration.

In some examples, the single payload indicates up to two CQIs and up to two PMIs determined for the set of multiple downlink subbands of the SBFD slot.

In some cases, the configuration manager 1025, the CSI reference signal manager 1030, the CSI report manager 1035, the PMI manager 1040, the subband report manager 1045, and the payload manager 1050 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the configuration manager 1025, the CSI reference signal manager 1030, the CSI report manager 1035, the PMI manager 1040, the subband report manager 1045, and the payload manager 1050 discussed herein.

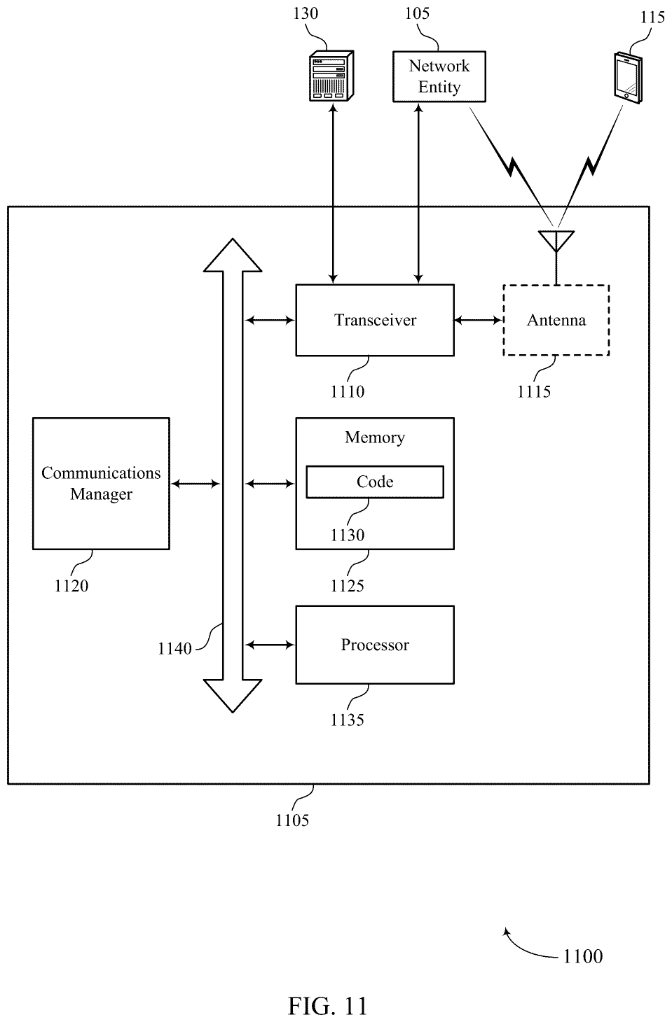

FIG. 11 shows a diagram of a system 1100 including a device 1105 that supports wideband and per-subband CSI reporting for SBFD communications in accordance with one or more aspects of the present disclosure. The device 1105 may be an example of or include the components of a device 805, a device 905, or a network node 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting wideband CSI reporting for SBFD communications). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

For example, the communications manager 1120 is capable of, configured to, or operable to support a means for transmitting a control message indicating a CSI reporting configuration for a SBFD slot, where the CSI reporting configuration indicates that a UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot. The communications manager 1120 is capable of, configured to, or operable to support a means for transmitting a first CSI reference signal via the first downlink subband of the SBFD slot and a second CSI reference signal via the second downlink subband of the SBFD slot. The communications manager 1120 is capable of, configured to, or operable to support a means for receiving, in accordance with the CSI reporting configuration, a CSI report indicating the first CSI for the first downlink subband of the SBFD slot and the second CSI for the second downlink subband of the SBFD slot.

By including or configuring the communications manager 1120 in accordance with examples as described herein, the device 1105 may support techniques for wideband and per-downlink subband CSI reporting for SBFD communications, which may improve communication reliability, improve spectral efficiency and data rates, improve coordination between wireless devices, and improve utilization of processing capability.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of wideband and per-subband CSI reporting for SBFD communications as described herein, or the processor 1135 and the memory 1125 may be otherwise configured to perform or support such operations.

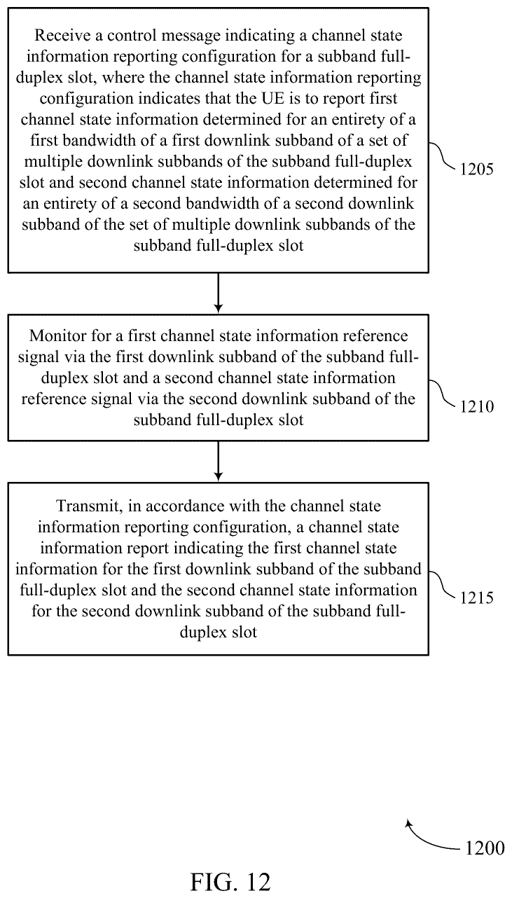

FIG. 12 shows a flowchart illustrating a method 1200 that supports wideband and per-subband CSI reporting for SBFD communications in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a control message indicating a CSI reporting configuration for a SBFD slot, where the CSI reporting configuration indicates that the UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot. The operations of block 1205 may be performed in accordance with examples as disclosed herein. In some examples, aspects of the operations of 1205 may be performed by a configuration component 625 as described with reference to FIG. 6.

At 1210, the method may include monitoring for a first CSI reference signal via the first downlink subband of the SBFD slot and a second CSI reference signal via the second downlink subband of the SBFD slot. The operations of block 1210 may be performed in accordance with examples as disclosed herein. In some examples, aspects of the operations of 1210 may be performed by a CSI reference signal component 630 as described with reference to FIG. 6.

At 1215, the method may include transmitting, in accordance with the CSI reporting configuration, a CSI report indicating the first CSI for the first downlink subband of the SBFD slot and the second CSI for the second downlink subband of the SBFD slot. The operations of block 1215 may be performed in accordance with examples as disclosed herein. In some examples, aspects of the operations of 1215 may be performed by a CSI report component 635 as described with reference to FIG. 6.

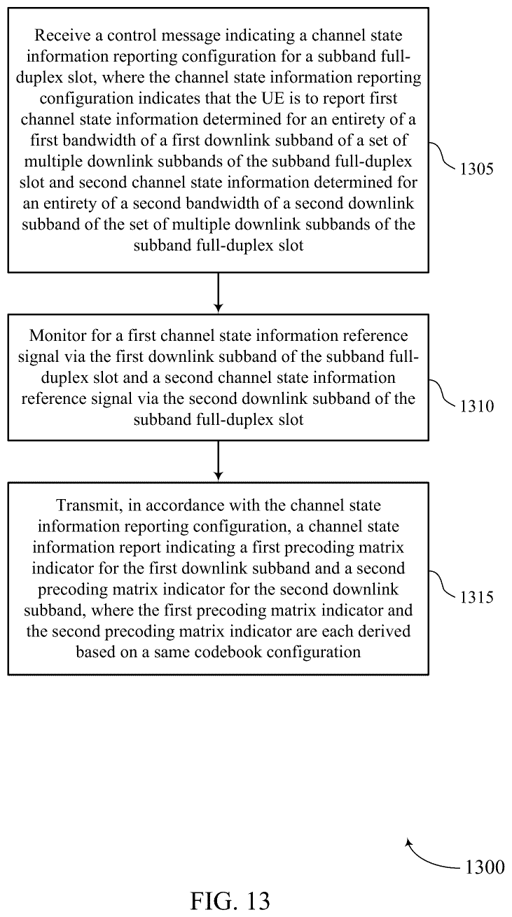

FIG. 13 shows a flowchart illustrating a method 1300 that supports wideband and per-subband CSI reporting for SBFD communications in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving a control message indicating a CSI reporting configuration for a SBFD slot, where the CSI reporting configuration indicates that the UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot. The operations of block 1305 may be performed in accordance with examples as disclosed herein. In some examples, aspects of the operations of 1305 may be performed by a configuration component 625 as described with reference to FIG. 6.

At 1310, the method may include monitoring for a first CSI reference signal via the first downlink subband of the SBFD slot and a second CSI reference signal via the second downlink subband of the SBFD slot. The operations of block 1310 may be performed in accordance with examples as disclosed herein. In some examples, aspects of the operations of 1310 may be performed by a CSI reference signal component 630 as described with reference to FIG. 6.

At 1315, the method may include transmitting, in accordance with the CSI reporting configuration, a CSI report indicating a first PMI for the first downlink subband and a second PMI for the second downlink subband, where the first PMI and the second PMI are each derived based on a same codebook configuration. The operations of block 1315 may be performed in accordance with examples as disclosed herein. In some examples, aspects of the operations of 1315 may be performed by a PMI component 640 as described with reference to FIG. 6.

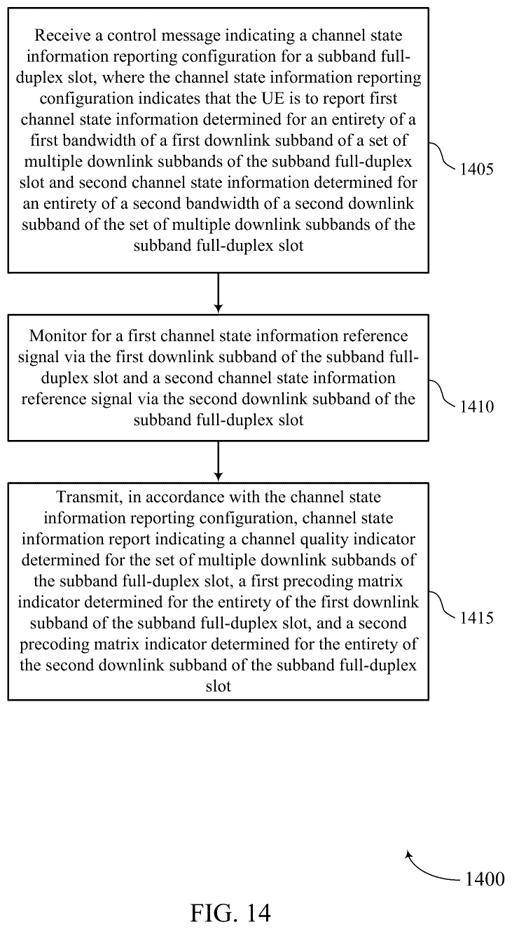

FIG. 14 shows a flowchart illustrating a method 1400 that supports wideband and per-subband CSI reporting for SBFD communications in accordance with aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include receiving a control message indicating a CSI reporting configuration for a SBFD slot, where the CSI reporting configuration indicates that the UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot. The operations of block 1405 may be performed in accordance with examples as disclosed herein. In some examples, aspects of the operations of 1405 may be performed by a configuration component 625 as described with reference to FIG. 6.

At 1410, the method may include monitoring for a first CSI reference signal via the first downlink subband of the SBFD slot and a second CSI reference signal via the second downlink subband of the SBFD slot. The operations of block 1410 may be performed in accordance with examples as disclosed herein. In some examples, aspects of the operations of 1410 may be performed by a CSI reference signal component 630 as described with reference to FIG. 6.

At 1415, the method may include transmitting, in accordance with the CSI reporting configuration, a CSI report indicating a CQI determined for the set of multiple downlink subbands of the SBFD slot, a first PMI determined for the entirety of the first downlink subband of the SBFD slot, and a second PMI determined for the entirety of the second downlink subband of the SBFD slot. The operations of block 1415 may be performed in accordance with examples as disclosed herein. In some examples, aspects of the operations of 1415 may be performed by a subband report component 645 as described with reference to FIG. 6.

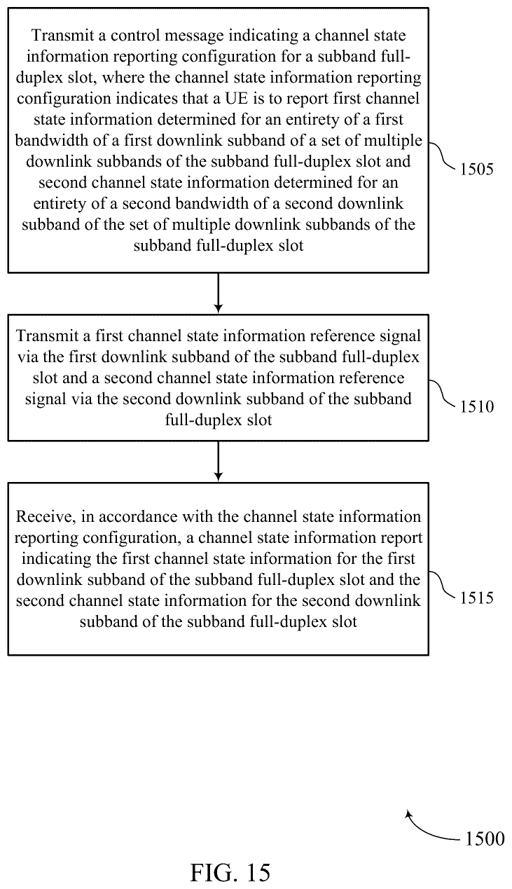

FIG. 15 shows a flowchart illustrating a method 1500 that supports wideband and per-subband CSI reporting for SBFD communications in accordance with aspects of the present disclosure. The operations of the method 1500 may be implemented by a network node or its components as described herein. For example, the operations of the method 1500 may be performed by a network node as described with reference to FIGS. 1 through 3 and 8 through 11. In some examples, a network node may execute a set of instructions to control the functional elements of the network node to perform the described functions. Additionally, or alternatively, the network node may perform aspects of the described functions using special-purpose hardware.

At 1505, the method may include transmitting a control message indicating a CSI reporting configuration for a SBFD slot, where the CSI reporting configuration indicates that a UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot. The operations of block 1505 may be performed in accordance with examples as disclosed herein. In some examples, aspects of the operations of 1505 may be performed by a configuration manager 1025 as described with reference to FIG. 10.

At 1510, the method may include transmitting a first CSI reference signal via the first downlink subband of the SBFD slot and a second CSI reference signal via the second downlink subband of the SBFD slot. The operations of block 1510 may be performed in accordance with examples as disclosed herein. In some examples, aspects of the operations of 1510 may be performed by a CSI reference signal manager 1030 as described with reference to FIG. 10.

At 1515, the method may include receiving, in accordance with the CSI reporting configuration, a CSI report indicating the first CSI for the first downlink subband of the SBFD slot and the second CSI for the second downlink subband of the SBFD slot. The operations of block 1515 may be performed in accordance with examples as disclosed herein. In some examples, aspects of the operations of 1515 may be performed by a CSI report manager 1035 as described with reference to FIG. 10.

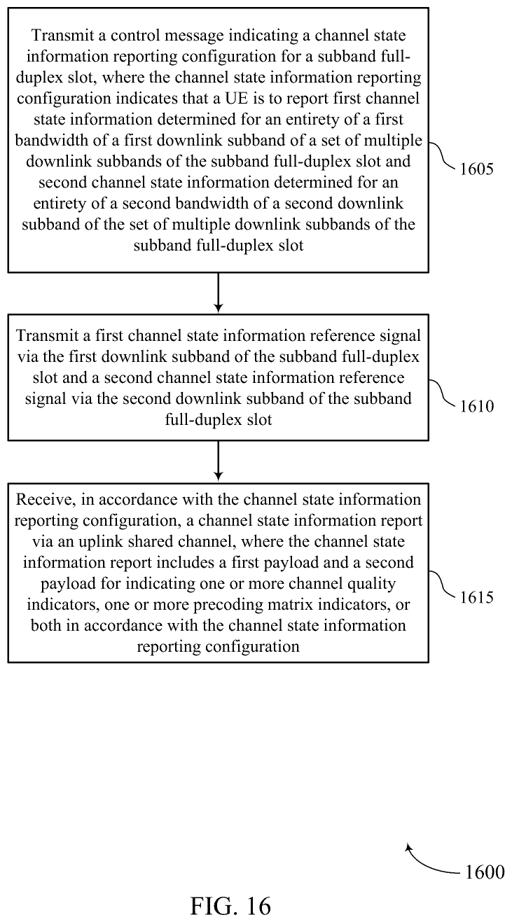

FIG. 16 shows a flowchart illustrating a method 1600 that supports wideband and per-subband CSI reporting for SBFD communications in accordance with aspects of the present disclosure. The operations of the method 1600 may be implemented by a network node or its components as described herein. For example, the operations of the method 1600 may be performed by a network node as described with reference to FIGS. 1 through 3 and 8 through 11. In some examples, a network node may execute a set of instructions to control the functional elements of the network node to perform the described functions. Additionally, or alternatively, the network node may perform aspects of the described functions using special-purpose hardware.

At 1605, the method may include transmitting a control message indicating a CSI reporting configuration for a SBFD slot, where the CSI reporting configuration indicates that a UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot. The operations of block 1605 may be performed in accordance with examples as disclosed herein. In some examples, aspects of the operations of 1605 may be performed by a configuration manager 1025 as described with reference to FIG. 10.

At 1610, the method may include transmitting a first CSI reference signal via the first downlink subband of the SBFD slot and a second CSI reference signal via the second downlink subband of the SBFD slot. The operations of block 1610 may be performed in accordance with examples as disclosed herein. In some examples, aspects of the operations of 1610 may be performed by a CSI reference signal manager 1030 as described with reference to FIG. 10.

At 1615, the method may include receiving, in accordance with the CSI reporting configuration, a CSI report via an uplink shared channel, where the CSI report includes a first payload and a second payload for indicating one or more CQIs, one or more PMIs, or both in accordance with the CSI reporting configuration. The operations of block 1615 may be performed in accordance with examples as disclosed herein. In some examples, aspects of the operations of 1615 may be performed by a payload manager 1050 as described with reference to FIG. 10.

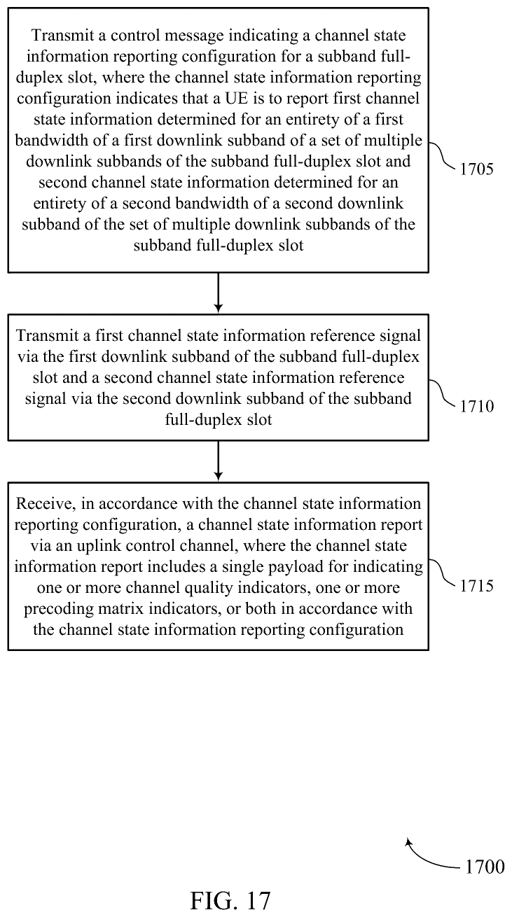

FIG. 17 shows a flowchart illustrating a method 1700 that supports wideband and per-subband CSI reporting for SBFD communications in accordance with aspects of the present disclosure. The operations of the method 1700 may be implemented by a network node or its components as described herein. For example, the operations of the method 1700 may be performed by a network node as described with reference to FIGS. 1 through 3 and 8 through 11. In some examples, a network node may execute a set of instructions to control the functional elements of the network node to perform the described functions. Additionally, or alternatively, the network node may perform aspects of the described functions using special-purpose hardware.

At 1705, the method may include transmitting a control message indicating a CSI reporting configuration for a SBFD slot, where the CSI reporting configuration indicates that a UE is to report first CSI determined for an entirety of a first bandwidth of a first downlink subband of a set of multiple downlink subbands of the SBFD slot and second CSI determined for an entirety of a second bandwidth of a second downlink subband of the set of multiple downlink subbands of the SBFD slot. The operations of block 1705 may be performed in accordance with examples as disclosed herein. In some examples, aspects of the operations of 1705 may be performed by a configuration manager 1025 as described with reference to FIG. 10.

At 1710, the method may include transmitting a first CSI reference signal via the first downlink subband of the SBFD slot and a second CSI reference signal via the second downlink subband of the SBFD slot. The operations of block 1710 may be performed in accordance with examples as disclosed herein. In some examples, aspects of the operations of 1710 may be performed by a CSI reference signal manager 1030 as described with reference to FIG. 10.

At 1715, the method may include receiving, in accordance with the CSI reporting configuration, a CSI report via an uplink control channel, where the CSI report includes a single payload for indicating one or more CQIs, one or more PMIs, or both in accordance with the CSI reporting configuration. The operations of block 1715 may be performed in accordance with examples as disclosed herein. In some examples, aspects of the operations of 1715 may be performed by a payload manager 1050 as described with reference to FIG. 10.

The following provides an overview of aspects of the present disclosure:

Aspect 1: A method for wireless communications at a UE comprising: receiving a control message indicating a CSI reporting configuration for a SBFD slot, wherein the CSI reporting configuration indicates that the UE is to report first CSI determined for an entirety of a first bandwidth of a first downlink subband of a plurality of downlink subbands of the SBFD slot and second CSI determined for an entirety of a second bandwidth of a second downlink subband of the plurality of downlink subbands of the SBFD slot; monitoring for a first CSI reference signal via the first downlink subband of the SBFD slot and a second CSI reference signal via the second downlink subband of the SBFD slot; and transmitting, in accordance with the CSI reporting configuration, a CSI report indicating the first CSI for the first downlink subband of the SBFD slot and the second CSI for the second downlink subband of the SBFD slot.

Aspect 2: The method of aspect 1, wherein the CSI reporting configuration indicates that the UE is to report CSI for an entirety of an allocated downlink bandwidth configured for the SBFD slot.

Aspect 3: The method of any of aspects 1 through 2, wherein the CSI reporting configuration indicates that the UE is to report CSI for a plurality of CSI subbands that correspond to the first downlink subband and the second downlink subband.

Aspect 4: The method of aspect 3, wherein a size of one of the plurality of CSI subbands is the same as a size of one of the first downlink subband or the second downlink subband.

Aspect 5: The method of any of aspects 1 through 4, wherein transmitting the CSI report comprises: transmitting the CSI report indicating a first PMI for the first downlink subband and a second PMI for the second downlink subband, wherein the first PMI and the second PMI are each derived based at least in part on a same codebook configuration.

Aspect 6: The method of any of aspects 1 through 5, wherein transmitting the CSI report comprises: transmitting the CSI report indicating a CQI determined for the plurality of downlink subbands of the SBFD slot, a first PMI determined for the entirety of the first downlink subband of the SBFD slot, and a second PMI determined for the entirety of the second downlink subband of the SBFD slot.

Aspect 7: The method of any of aspects 1 through 6, wherein the CSI report is an aperiodic CSI report, and wherein transmitting the aperiodic CSI report comprises: transmitting the aperiodic CSI report indicating a CQI determined for the plurality of downlink subbands of the SBFD slot, a first PMI determined for the entirety of the first downlink subband of the SBFD slot, and a second PMI determined for the entirety of the second downlink subband of the SBFD slot.

Aspect 8: The method of any of aspects 1 through 7, wherein the CSI report is a periodic CSI report or a semi-persistent CSI report, and wherein transmitting the periodic CSI report or the semi-persistent CSI report comprises: transmitting a first periodic or semi-persistent CSI report indicating a first CQI determined for the plurality of downlink subbands of the SBFD slot, a first PMI determined for the entirety of the first downlink subband of the SBFD slot, and a second PMI determined for the entirety of the second downlink subband of the SBFD slot; and transmitting a second periodic or semi-persistent CSI report indicating a second CQI determined for the first downlink subband and a third CQI determined for the second downlink subband, a third PMI determined for the entirety of the first downlink subband of the SBFD slot, and a fourth PMI determined for the entirety of the second downlink subband of the SBFD slot.

Aspect 9: The method of any of aspects 1 through 8, wherein transmitting the CSI report comprises: transmitting the CSI report via an uplink shared channel, wherein the CSI report comprises a first payload and a second payload for indicating one or more CQIs, one or more PMIs, or both in accordance with the CSI reporting configuration.

Aspect 10: The method of aspect 9, wherein the first payload indicates an average CQI, an average PMI, or both determined for the plurality of downlink subbands of the SBFD slot, and wherein the second payload indicates a first PMI determined for the entirety of the first downlink subband of the SBFD slot, and a second PMI determined for the entirety of the second downlink subband of the SBFD slot.

Aspect 11: The method of any of aspects 9 through 10, wherein the first payload indicates a first channel quality matrix indicator determined for the entirety of the first downlink subband of the SBFD slot, and a second channel quality matrix indicator determined for the entirety of the second downlink subband of the SBFD slot, and wherein the second payload indicates a first PMI determined for the entirety of the first downlink subband of the SBFD slot, and a second PMI determined for the entirety of the second downlink subband of the SBFD slot.

Aspect 12: The method of any of aspects 1 through 11, wherein transmitting the CSI report comprises: transmitting the CSI report via an uplink control channel, wherein the CSI report comprises a single payload for indicating one or more CQIs, one or more PMIs, or both in accordance with the CSI reporting configuration.

Aspect 13: The method of aspect 12, wherein the single payload indicates up to two CQIs and up to two PMIs determined for the plurality of downlink subbands of the SBFD slot.

Aspect 14: The method of any of aspects 1 through 13, further comprising: receiving a configuration message indicating a SBFD slot configuration, the SBFD slot configuration indicating that the SBFD slot comprises the plurality of downlink subbands and that the first downlink subband and the second downlink subband are non-contiguous downlink subbands.

Aspect 15: A method for wireless communications at a network entity comprising: transmitting a control message indicating a CSI reporting configuration for a SBFD slot, wherein the CSI reporting configuration indicates that a UE is to report first CSI determined for an entirety of a first bandwidth of a first downlink subband of a plurality of downlink subbands of the SBFD slot and second CSI determined for an entirety of a second bandwidth of a second downlink subband of the plurality of downlink subbands of the SBFD slot; transmitting a first CSI reference signal via the first downlink subband of the SBFD slot and a second CSI reference signal via the second downlink subband of the SBFD slot; and receiving, in accordance with the CSI reporting configuration, a CSI report indicating the first CSI for the first downlink subband of the SBFD slot and the second CSI for the second downlink subband of the SBFD slot.

Aspect 16: The method of aspect 15, wherein the CSI reporting configuration indicates that the UE is to report CSI for an entirety of an allocated downlink bandwidth configured for the SBFD slot.

Aspect 17: The method of any of aspects 15 through 16, wherein the CSI reporting configuration indicates that the UE is to report CSI for a plurality of CSI subbands that correspond to the first downlink subband and the second downlink subband.

Aspect 18: The method of aspect 17, wherein a size of one of the plurality of CSI subbands is the same as a size of one of the first downlink subband or the second downlink subband.

Aspect 19: The method of any of aspects 15 through 18, wherein receiving the CSI report comprises: receiving the CSI report indicating a first PMI for the first downlink subband and a second PMI for the second downlink subband, wherein the first PMI and the second PMI are each derived based at least in part on a same codebook configuration.

Aspect 20: The method of any of aspects 15 through 19, wherein receiving the CSI report comprises: receiving the CSI report indicating a CQI determined for the plurality of downlink subbands of the SBFD slot, a first PMI determined for the entirety of the first downlink subband of the SBFD slot, and a second PMI determined for the entirety of the second downlink subband of the SBFD slot.

Aspect 21: The method of any of aspects 15 through 20, wherein the CSI report is an aperiodic CSI report, and wherein receiving the aperiodic CSI report comprises: receiving the aperiodic CSI report indicating a CQI determined for the plurality of downlink subbands of the SBFD slot, a first PMI determined for the entirety of the first downlink subband of the SBFD slot, and a second PMI determined for the entirety of the second downlink subband of the SBFD slot.

Aspect 22: The method of any of aspects 15 through 21, wherein the CSI report is a periodic CSI report or a semi-persistent CSI report, and wherein receiving the periodic CSI report or the semi-persistent CSI report comprises: receiving a first periodic or semi-persistent CSI report indicating a first CQI determined for the plurality of downlink subbands of the SBFD slot, a first PMI determined for the entirety of the first downlink subband of the SBFD slot, and a second PMI determined for the entirety of the second downlink subband of the SBFD slot; and receiving a second periodic or semi-persistent CSI report indicating a second CQI determined for the first downlink subband and a third CQI determined for the second downlink subband, a third PMI determined for the entirety of the first downlink subband of the SBFD slot, and a fourth PMI determined for the entirety of the second downlink subband of the SBFD slot.

Aspect 23: The method of any of aspects 15 through 22, wherein receiving the CSI report comprises: receiving the CSI report via an uplink shared channel, wherein the CSI report comprises a first payload and a second payload for indicating one or more CQIs, one or more PMIs, or both in accordance with the CSI reporting configuration.

Aspect 24: The method of aspect 23, wherein the first payload indicates an average CQI, an average PMI, or both determined for the plurality of downlink subbands of the SBFD slot, and wherein the second payload indicates a first PMI determined for the entirety of the first downlink subband of the SBFD slot, and a second PMI determined for the entirety of the second downlink subband of the SBFD slot.

Aspect 25: The method of any of aspects 23 through 24, wherein the first payload indicates a first channel quality matrix indicator determined for the entirety of the first downlink subband of the SBFD slot, and a second channel quality matrix indicator determined for the entirety of the second downlink subband of the SBFD slot, and wherein the second payload indicates a first PMI determined for the entirety of the first downlink subband of the SBFD slot, and a second PMI determined for the entirety of the second downlink subband of the SBFD slot.

Aspect 26: The method of any of aspects 15 through 25, wherein receiving the CSI report comprises: receiving the CSI report via an uplink control channel, wherein the CSI report comprises a single payload for indicating one or more CQIs, one or more PMIs, or both in accordance with the CSI reporting configuration.

Aspect 27: The method of aspect 26, wherein the single payload indicates up to two CQIs and up to two PMIs determined for the plurality of downlink subbands of the SBFD slot.

Aspect 28: An apparatus for wireless communication at a UE, comprising one or more memories; and one or more processors coupled to the one or more memories, the one or more processors configured to perform a method of any of aspects 1 through 14.

Aspect 29: An apparatus for wireless communication at a UE, comprising at least one means for performing a method of any of aspects 1 through 14.

Aspect 30: A non-transitory computer-readable medium storing code for wireless communication at a UE, the code comprising instructions executable by a processor to perform a method of any of aspects 1 through 14.

Aspect 31: An apparatus for wireless communication at a network entity, comprising one or more memories; and one or more processors coupled to the one or more memories, the one or more processors configured to cause the apparatus to perform a method of any of aspects 15 through 27.

Aspect 32: An apparatus for wireless communication at a network entity, comprising at least one means for performing a method of any of aspects 15 through 27.

Aspect 33: A non-transitory computer-readable medium storing code for wireless communication at a network entity, the code comprising instructions executable by a processor to perform a method of any of aspects 15 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

Any functions or operations described herein as being capable of being performed by a processor may be performed by multiple processors that, individually or collectively, are capable of performing the described functions or operations. For example, the functions described herein may be performed by multiple processors, each tasked with at least a subset of the described functions, such that, collectively, the multiple processors perform all of the described functions. As such, the described functions can be performed by a single processor or a group of processors functioning together (i.e., collectively) to perform the described functions, where any one processor performs at least a subset of the described functions.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

Any functions or operations described herein as being capable of being performed by a memory may be performed by multiple memories that, individually or collectively, are capable of performing the described functions or operations. For example, the functions described herein may be performed by multiple memories, each tasked with at least a subset of the described functions, such that, collectively, the multiple memories perform all of the described functions. As such, the described functions can be performed by a single memory or a group of memories functioning together (i.e., collectively) to perform the described functions, where any one memory performs at least a subset of the described functions.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more memories; and
one or more processors coupled to the one or more memories, the one or more processors configured to cause the apparatus to:
receive a control message indicating a channel state information reporting configuration for a subband full-duplex slot, wherein the channel state information reporting configuration indicates that the UE is to report first channel state information determined for an entirety of a first bandwidth of a first downlink subband of a plurality of downlink subbands of the subband full-duplex slot and second channel state information determined for an entirety of a second bandwidth of a second downlink subband of the plurality of downlink subbands of the subband full-duplex slot;
monitor for a first channel state information reference signal via the first downlink subband of the subband full-duplex slot and a second channel state information reference signal via the second downlink subband of the subband full-duplex slot; and
transmit, in accordance with the channel state information reporting configuration, a channel state information report indicating the first channel state information for the first downlink subband of the subband full-duplex slot and the second channel state information for the second downlink subband of the subband full-duplex slot.

2. The apparatus of claim 1, wherein the channel state information reporting configuration indicates that the UE is to report channel state information for an entirety of an allocated downlink bandwidth configured for the subband full-duplex slot.

3. The apparatus of claim 1, wherein the channel state information reporting configuration indicates that the UE is to report channel state information for a plurality of channel state information subbands that correspond to the first downlink subband and the second downlink subband.

4. The apparatus of claim 3, wherein a size of one of the plurality of channel state information subbands is the same as a size of one of the first downlink subband or the second downlink subband.

5. The apparatus of claim 1, wherein, to transmit the channel state information report, the one or more processors are configured to cause the apparatus to:
transmit the channel state information report indicating a first precoding matrix indicator for the first downlink subband and a second precoding matrix indicator for the second downlink subband, wherein the first precoding matrix indicator and the second precoding matrix indicator are each derived based at least in part on a same codebook configuration.

6. The apparatus of claim 1, wherein, to transmit the channel state information report, the one or more processors are configured to cause the apparatus to:
transmit the channel state information report indicating a channel quality indicator determined for the plurality of downlink subbands of the subband full-duplex slot, a first precoding matrix indicator determined for the entirety of the first downlink subband of the subband full-duplex slot, and a second precoding matrix indicator determined for the entirety of the second downlink subband of the subband full-duplex slot.

7. The apparatus of claim 1, wherein the channel state information report is an aperiodic channel state information report, and wherein, to transmit the aperiodic channel state information report, the one or more processors are configured to cause the apparatus to:
transmit the aperiodic channel state information report indicating a channel quality indicator determined for the plurality of downlink subbands of the subband full-duplex slot, a first precoding matrix indicator determined for the entirety of the first downlink subband of the subband full-duplex slot, and a second precoding matrix indicator determined for the entirety of the second downlink subband of the subband full-duplex slot.

8. The apparatus of claim 1, wherein the channel state information report is a periodic channel state information report or a semi-persistent channel state information report, and wherein, to transmit the periodic channel state information report or the semi-persistent channel state information report, the one or more processors are configured to cause the apparatus to:
transmit a first periodic or semi-persistent channel state information report indicating a first channel quality indicator determined for the plurality of downlink subbands of the subband full-duplex slot, a first precoding matrix indicator determined for the entirety of the first downlink subband of the subband full-duplex slot, and a second precoding matrix indicator determined for the entirety of the second downlink subband of the subband full-duplex slot; and
transmit a second periodic or semi-persistent channel state information report indicating a second channel quality indicator determined for the first downlink subband and a third channel quality indicator determined for the second downlink subband, a third precoding matrix indicator determined for the entirety of the first downlink subband of the subband full-duplex slot, and a fourth precoding matrix indicator determined for the entirety of the second downlink subband of the subband full-duplex slot.

9. The apparatus of claim 1, wherein, to transmit the channel state information report, the one or more processors are configured to cause the apparatus to:
transmit the channel state information report via an uplink shared channel, wherein the channel state information report comprises a first payload and a second payload for indicating one or more channel quality indicators, one or more precoding matrix indicators, or both in accordance with the channel state information reporting configuration.

10. The apparatus of claim 9, wherein the first payload indicates an average channel quality indicator, an average precoding matrix indicator, or both determined for the plurality of downlink subbands of the subband full-duplex slot, and wherein the second payload indicates a first precoding matrix indicator determined for the entirety of the first downlink subband of the subband full-duplex slot, and a second precoding matrix indicator determined for the entirety of the second downlink subband of the subband full-duplex slot.

11. The apparatus of claim 9, wherein the first payload indicates a first channel quality matrix indicator determined for the entirety of the first downlink subband of the subband full-duplex slot, and a second channel quality matrix indicator determined for the entirety of the second downlink subband of the subband full-duplex slot, and wherein the second payload indicates a first precoding matrix indicator determined for the entirety of the first downlink subband of the subband full-duplex slot, and a second precoding matrix indicator determined for the entirety of the second downlink subband of the subband full-duplex slot.

12. The apparatus of claim 1, wherein, to transmit the channel state information report, the one or more processors are configured to cause the apparatus to:
transmit the channel state information report via an uplink control channel, wherein the channel state information report comprises a single payload for indicating one or more channel quality indicators, one or more precoding matrix indicators, or both in accordance with the channel state information reporting configuration.

13. The apparatus of claim 12, wherein the single payload indicates up to two channel quality indicators and up to two precoding matrix indicators determined for the plurality of downlink subbands of the subband full-duplex slot.

14. The apparatus of claim 1, wherein the one or more processors are configured to cause the apparatus to:
receive a configuration message indicating a subband full-duplex slot configuration, the subband full-duplex slot configuration indicating that the subband full-duplex slot comprises the plurality of downlink subbands and that the first downlink subband and the second downlink subband are non-contiguous downlink subbands.

15. An apparatus for wireless communication at a network node, comprising:
one or more memories; and
one or more processors coupled to the one or more memories, the one or more processors configured to cause the apparatus to:
transmit a control message indicating a channel state information reporting configuration for a subband full-duplex slot, wherein the channel state information reporting configuration indicates that a user equipment (UE) is to report first channel state information determined for an entirety of a first bandwidth of a first downlink subband of a plurality of downlink subbands of the subband full-duplex slot and second channel state information determined for an entirety of a second bandwidth of a second downlink subband of the plurality of downlink subbands of the subband full-duplex slot;
transmit a first channel state information reference signal via the first downlink subband of the subband full-duplex slot and a second channel state information reference signal via the second downlink subband of the subband full-duplex slot; and
receive, in accordance with the channel state information reporting configuration, a channel state information report indicating the first channel state information for the first downlink subband of the subband full-duplex slot and the second channel state information for the second downlink subband of the subband full-duplex slot.

16. The apparatus of claim 15, wherein the channel state information reporting configuration indicates that the UE is to report channel state information for an entirety of an allocated downlink bandwidth configured for the subband full-duplex slot.

17. The apparatus of claim 15, wherein the channel state information reporting configuration indicates that the UE is to report channel state information for a plurality of channel state information subbands that correspond to the first downlink subband and the second downlink subband.

18. The apparatus of claim 17, wherein a size of one of the plurality of channel state information subbands is the same as a size of one of the first downlink subband or the second downlink subband.

19. The apparatus of claim 15, wherein, to receive the channel state information report, the one or more processors are configured to cause the apparatus to:
receive the channel state information report indicating a first precoding matrix indicator for the first downlink subband and a second precoding matrix indicator for the second downlink subband, wherein the first precoding matrix indicator and the second precoding matrix indicator are each derived based at least in part on a same codebook configuration.

20. The apparatus of claim 15, wherein, to receive the channel state information report, the one or more processors are configured to cause the apparatus to:
receive the channel state information report indicating a channel quality indicator determined for the plurality of downlink subbands of the subband full-duplex slot, a first precoding matrix indicator determined for the entirety of the first downlink subband of the subband full-duplex slot, and a second precoding matrix indicator determined for the entirety of the second downlink subband of the subband full-duplex slot.

21. The apparatus of claim 15, wherein the channel state information report is an aperiodic channel state information report, and wherein, to receive the aperiodic channel state information report, the one or more processors are configured to cause the apparatus to:
receive the aperiodic channel state information report indicating a channel quality indicator determined for the plurality of downlink subbands of the subband full-duplex slot, a first precoding matrix indicator determined for the entirety of the first downlink subband of the subband full-duplex slot, and a second precoding matrix indicator determined for the entirety of the second downlink subband of the subband full-duplex slot.

22. The apparatus of claim 15, wherein the channel state information report is a periodic channel state information report or a semi-persistent channel state information report, and wherein, to receive the periodic channel state information report or the semi-persistent channel state information report, the one or more processors are configured to cause the apparatus to:
receive a first periodic or semi-persistent channel state information report indicating a first channel quality indicator determined for the plurality of downlink subbands of the subband full-duplex slot, a first precoding matrix indicator determined for the entirety of the first downlink subband of the subband full-duplex slot, and a second precoding matrix indicator determined for the entirety of the second downlink subband of the subband full-duplex slot; and
receive a second periodic or semi-persistent channel state information report indicating a second channel quality indicator determined for the first downlink subband and a third channel quality indicator determined for the second downlink subband, a third precoding matrix indicator determined for the entirety of the first downlink subband of the subband full-duplex slot, and a fourth precoding matrix indicator determined for the entirety of the second downlink subband of the subband full-duplex slot.

23. The apparatus of claim 15, wherein, to receive the channel state information report, the one or more processors are configured to cause the apparatus to:
receive the channel state information report via an uplink shared channel, wherein the channel state information report comprises a first payload and a second payload for indicating one or more channel quality indicators, one or more precoding matrix indicators, or both in accordance with the channel state information reporting configuration.

24. The apparatus of claim 23, wherein the first payload indicates an average channel quality indicator, an average precoding matrix indicator, or both determined for the plurality of downlink subbands of the subband full-duplex slot, and wherein the second payload indicates a first precoding matrix indicator determined for the entirety of the first downlink subband of the subband full-duplex slot, and a second precoding matrix indicator determined for the entirety of the second downlink subband of the subband full-duplex slot.

25. The apparatus of claim 23, wherein the first payload indicates a first channel quality matrix indicator determined for the entirety of the first downlink subband of the subband full-duplex slot, and a second channel quality matrix indicator determined for the entirety of the second downlink subband of the subband full-duplex slot, and wherein the second payload indicates a first precoding matrix indicator determined for the entirety of the first downlink subband of the subband full-duplex slot, and a second precoding matrix indicator determined for the entirety of the second downlink subband of the subband full-duplex slot.

26. The apparatus of claim 15, wherein, to receive the channel state information report, the one or more processors are configured to cause the apparatus to:
receive the channel state information report via an uplink control channel, wherein the channel state information report comprises a single payload for indicating one or more channel quality indicators, one or more precoding matrix indicators, or both in accordance with the channel state information reporting configuration.

27. The apparatus of claim 26, wherein the single payload indicates up to two channel quality indicators and up to two precoding matrix indicators determined for the plurality of downlink subbands of the subband full-duplex slot.

28. A method for wireless communication at a user equipment (UE) comprising:
receiving a control message indicating a channel state information reporting configuration for a subband full-duplex slot, wherein the channel state information reporting configuration indicates that the UE is to report first channel state information determined for an entirety of a first bandwidth of a first downlink subband of a plurality of downlink subbands of the subband full-duplex slot and second channel state information determined for an entirety of a second bandwidth of a second downlink subband of the plurality of downlink subbands of the subband full-duplex slot;
monitoring for a first channel state information reference signal via the first downlink subband of the subband full-duplex slot and a second channel state information reference signal via the second downlink subband of the subband full-duplex slot; and
transmitting, in accordance with the channel state information reporting configuration, a channel state information report indicating the first channel state information for the first downlink subband of the subband full-duplex slot and the second channel state information for the second downlink subband of the subband full-duplex slot.

29. The method of claim 28, wherein the channel state information reporting configuration indicates that the UE is to report channel state information for an entirety of an allocated downlink bandwidth configured for the subband full-duplex slot.

30. A method for wireless communication at a network node comprising:
transmitting a control message indicating a channel state information reporting configuration for a subband full-duplex slot, wherein the channel state information reporting configuration indicates that a user equipment (UE) is to report first channel state information determined for an entirety of a first bandwidth of a first downlink subband of a plurality of downlink subbands of the subband full-duplex slot and second channel state information determined for an entirety of a second bandwidth of a second downlink subband of the plurality of downlink subbands of the subband full-duplex slot;
transmitting a first channel state information reference signal via the first downlink subband of the subband full-duplex slot and a second channel state information reference signal via the second downlink subband of the subband full-duplex slot; and
receiving, in accordance with the channel state information reporting configuration, a channel state information report indicating the first channel state information for the first downlink subband of the subband full-duplex slot and the second channel state information for the second downlink subband of the subband full-duplex slot.
